(19) United States
(12) Patent Application Publication
(10) Pub. No.: US 2014/0272575 A1
(43) Pub. Date: Sep. 18, 2014

(54) BINDER FOR RECHARGEABLE LITHIUM BATTERY, ELECTRODE FOR RECHARGEABLE LITHIUM BATTERY INCLUDING BINDER, METHOD OF PREPARING ELECTRODE FOR RECHARGEABLE LITHIUM BATTERY, AND RECHARGEABLE LITHIUM BATTERY INCLUDING ELECTRODE

(71) Applicants: AEKYUNG CHEMICAL CO., LTD., Seoul (KR); SAMSUNG SDI CO., LTD., Yongin-si (KR)

(72) Inventors: Eon-Mi LEE, Yongin-si (KR); Byung-Joo CHUNG, Yongin-si (KR); Nam-Seon KIM, Daejeon-si (KR); Yang-Soo KIM, Daejeon-si (KR); Kwang-Sik CHOI, Daejeon-si (KR)

(73) Assignees: AEKYUNG CHEMICAL CO., LTD., Seoul (KR); SAMSUNG SDI CO., LTD., Yongin-si (KR)

(21) Appl. No.: 14/204,353

(22) Filed: Mar. 11, 2014

(30) Foreign Application Priority Data
Mar. 15, 2013 (KR) 10-2013-0028222

(51) Int. Cl. H01M 4/62; H01M 4/04; H01M 4/139; H01M 10/0525

(52) U.S. Cl. CPC H01M 4/622; H01M 10/0525; H01M 4/0404; H01M 4/0471; H01M 4/139
USPC 429/217; 525/296; 525/288; 524/533; 427/58

(57) ABSTRACT

Embodiments are directed to a binder for a rechargeable lithium battery, the binder including a copolymer including a repeating unit represented by Chemical Formula X, a repeating unit represented by Chemical Formula Y-1, and a repeating unit represented by Chemical Formula Z, and lithium ions,

[chemical structure]

where Chemical Formula X, Chemical Formula Y-1, and Chemical Formula Z are as described herein.

### CROSS-REFERENCE TO RELATED APPLICATION

Korean Patent Application No. 10-2013-0028222, filed on Mar. 15, 2013, in the Korean Intellectual Property Office, and entitled: “Binder For Rechargeable Lithium Battery, Electrode For Rechargeable Lithium Battery Including Binder, Method Of Preparing Electrode For Rechargeable Lithium Battery, and Rechargeable Lithium Battery Including Electrode,” is incorporated by reference herein in its entirety.

### BACKGROUND

1. Field

Embodiments relate to a binder for a rechargeable lithium battery, an electrode for a rechargeable lithium battery including the binder for a rechargeable lithium battery, a method of preparing the electrode for a rechargeable lithium battery, and a rechargeable lithium battery including the electrode for a rechargeable lithium battery.

2. Description of the Related Art

A rechargeable lithium battery includes positive and negative electrodes including a material that can reversibly intercalate/deintercalate lithium ions as positive and negative active materials and an organic electrolyte solution or a polymer electrolyte charged between the positive and negative electrodes. Herein, the positive and negative electrodes intercalate and deintercalate lithium ions and produce electrical energy through oxidation and reduction reactions.

### SUMMARY

Embodiments are directed to a binder for a rechargeable lithium battery, the binder including a copolymer including a repeating unit represented by Chemical Formula X, a repeating unit represented by Chemical Formula Y-1, and a repeating unit represented by Chemical Formula Z, and lithium ions.

A weight average molecular weight of the copolymer may be about 10,000 to about 500,000,

a mole ratio of the repeating unit represented by Chemical Formula X may be about 5% to about 35%, a mole ratio of the repeating unit represented by Chemical Formula Y-1 may be about 5% to about 35%, and a mole ratio of the repeating unit represented by Chemical Formula Z may be about 30% to about 90%,

[chemical structure]

wherein,

R¹ to R⁴ may each independently be hydrogen, a substituted or unsubstituted C1 to C30 alkyl group, or a substituted or unsubstituted C6 to C30 aryl group,

L may be a substituted or unsubstituted C2 to C10 alkenylene group, and

n may be 0 or 1,

[chemical structure]

wherein,

R⁵ and R⁶ may each independently be hydrogen, or a substituted or unsubstituted C1 to C30 alkyl group, and

R⁷ may be a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group,

[chemical structure]

wherein,

R¹¹ may be hydrogen, or a substituted or unsubstituted C1 to C30 alkyl group, and

R¹² and R¹³ may each independently be hydrogen, a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, or R¹² and R¹³ may be linked to each other to form a ring.

The lithium ions may be present in the binder in an amount of about 0.1 to about 10 moles, based on 100 moles of the copolymer.

The binder for a rechargeable lithium battery may be an aqueous binder.

The copolymer may further include at least one of repeating structures represented by Chemical Formulae W-1 to W-5:

[chemical structure]

wherein, R²¹, R²³, R²⁵, R²⁷, and R³⁰ may each independently be hydrogen, or a substituted or unsubstituted C1 to C30 alkyl group,

R²², R²⁴, and R²⁶ may each independently be hydrogen, a substituted or unsubstituted C1 to C30 alkyl group, a substituted or unsubstituted C2 to C20 alkenyl group, a substituted or unsubstituted C2 to C20 alkynyl group, a substituted or unsubstituted C3 to C8 cycloalkyl group, a substituted or unsubstituted C6 to C30 aryl group, a substituted or unsubstituted C1 to C30 heteroaryl group, a silane group, a C1 to C20 alkylsilane group, a C1 to C20 alkoxysilane group, or a C1 to C20 alkylamine group, and

R²⁸, R²⁹, R³¹, and R³² may each independently be hydrogen, a substituted or unsubstituted C1 to C30 alkyl group, a substituted or unsubstituted C2 to C20 alkenyl group, a substituted or unsubstituted C2 to C20 alkynyl group, a C3 to C8 cycloalkyl group, a substituted or unsubstituted C6 to C30 aryl group, a substituted or unsubstituted C1 to C30 heteroaryl group, a silane group, a C1 to C20 alkylsilane group, a C1 to C20 alkoxysilane group, or a C2 to C20 carbonyl group, or

R²⁸ and R²⁹ may be linked to each other to form a ring, and R³¹ and R³² may be linked to each other to form a ring.

Embodiments are also directed to an electrode for a rechargeable lithium battery, the electrode including a current collector, and an electrode composition disposed on one side or both sides of the current collector, the electrode composition including an active material and a binder.

The binder may include a copolymer including a repeating unit represented by

Chemical Formula X, a repeating unit represented by Chemical Formula Y-2, and a repeating unit represented by Chemical Formula Z, and lithium ions,

a weight average molecular weight of the copolymer may be about 10,000 to about 500,000,

a mole ratio of the repeating unit represented by Chemical Formula X may be about 5% to about 35%, a mole ratio of the repeating unit represented by Chemical Formula Y-2 may be about 5% to about 35%, and a mole ratio of the repeating unit represented by Chemical Formula Z may be about 30% to about 90%:

[chemical structure]

wherein,

R¹ to R⁴ may each be independently hydrogen, a substituted or unsubstituted C1 to C30 alkyl group, or a substituted or unsubstituted C6 to C30 aryl group,

L may be a substituted or unsubstituted C2 to C10 alkenylene group, and

n may be 0 or 1,

[chemical structure]

wherein,

R⁵ and R⁶ may each independently be hydrogen, or a substituted or unsubstituted C1 to C30 alkyl group, and

R⁷ may be a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group,

[chemical structure]

wherein,

R¹¹ may be hydrogen, or a substituted or unsubstituted C1 to C30 alkyl group, and

R¹² and R¹³ may each independently be hydrogen, a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, or R¹² and R¹³ are linked to each other to form a ring.

The repeating unit represented by the above Chemical Formula Y-2 may be prepared by heat-treating a repeating structure represented by Chemical Formula Y-1:

[chemical structure]

wherein,

R⁵ and R⁶ may each independently be hydrogen, or a substituted or unsubstituted C1 to C30 alkyl group, and

R⁷ may be a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group.

The copolymer may further include at least one of repeating structures represented by Chemical Formulae W-1 to W-5:

[chemical structure]

wherein,

R²¹, R²³, R²⁵, R²⁷, and R³⁰ may each independently be hydrogen, or a substituted or unsubstituted C1 to C30 alkyl group,

R²², R²⁴, and R²⁶ may each independently be hydrogen, a substituted or unsubstituted C1 to C30 alkyl group, a substituted or unsubstituted C2 to C20 alkenyl group, a substituted or unsubstituted C2 to C20 alkynyl group, a substituted or unsubstituted C3 to C8 cycloalkyl group, a substituted or unsubstituted C6 to C30 aryl group, a substituted or unsubstituted C1 to C30 heteroaryl group, a silane group, a C1 to C20 alkylsilane group, a C1 to C20 alkoxysilane group, or a C1 to C20 alkylamine group, and

in the above Chemical Formula W-4 and W-5, R²⁸, R²⁹, R³¹ and R³² may each independently be hydrogen, a substituted or unsubstituted C1 to C30 alkyl group, a substituted or unsubstituted C2 to C20 alkenyl group, a substituted or unsubstituted C2 to C20 alkynyl group, a C3 to C8 cycloalkyl group, a substituted or unsubstituted C6 to C30 aryl group, a substituted or unsubstituted C1 to C30 heteroaryl group, a silane group, a C1 to C20 alkylsilane group, a C1 to C20 alkoxysilane group, or a C2 to C20 carbonyl group, or

R²⁸ and R²⁹ may be linked to each other to form a ring, and R³¹ and R³² may be linked to each other to form a ring.

The active material may include Si, SiOₓ, a Si—C composite, a Si-Q alloy, graphite, or a combination thereof. X may be in the range of 0<x<2, and Q may be an alkali metal, an alkaline-earth metal, a Group 13 to 16 element, a transition element, a rare earth element, or a combination thereof but not Si.

Embodiments are also directed to a method of manufacturing the electrode for a rechargeable lithium battery, the method including mixing an active material, a solvent, and a binder to prepare an electrode composition, coating the electrode composition on a current collector, and heat-treating the current collector coated with the electrode composition.

The binder before heat-treating may include a copolymer including a repeating unit represented by Chemical Formula X, a repeating unit represented by Chemical Formula Y-1, and a repeating unit represented by Chemical Formula Z, and lithium ions,

the binder after heat-treating may include a copolymer including a repeating unit represented by Chemical Formula X, a repeating unit represented by Chemical Formula Y-2, and a repeating unit represented by Chemical Formula Z, and lithium ions,

a weight average molecular weight of the copolymer may be about 10,000 to about 500,000, and

a mole ratio of the repeating unit represented by Chemical Formula X may be about 5% to about 35%, a mole ratio of the repeating unit represented by Chemical Formula Y-2 may be about 5% to about 35%, and a mole ratio of the repeating unit represented by Chemical Formula Z may be about 30% to about 90%,

[chemical structure]

wherein, in the above Chemical Formula X,

R¹ to R⁴ may each independently be hydrogen, a substituted or unsubstituted C1 to C30 alkyl group, or a substituted or unsubstituted C6 to C30 aryl group,

L may be a substituted or unsubstituted C2 to C10 alkenylene group, and

n may be 0 or 1,

[chemical structure]

wherein,

R⁵ and R⁶ may each independently be hydrogen, or a substituted or unsubstituted C1 to C30 alkyl group, and

R⁷ may be a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group,

[chemical structure]

wherein,

R⁵ and R⁶ may each independently be hydrogen, or a substituted or unsubstituted C1 to C30 alkyl group, and

R⁷ may be a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group,

[chemical structure]

wherein,

R¹¹ may be hydrogen, or a substituted or unsubstituted C1 to C30 alkyl group, and

R¹² and R¹³ may each independently be hydrogen, a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, or R¹² and R¹³ may be linked to each other to form a ring.

The heat-treating may be performed at about 120° C. to about 300° C.

Embodiments are also directed to a rechargeable lithium battery including an electrode according to an embodiment, a separator, and an electrolyte.

Embodiments are also directed to a binder for a rechargeable lithium battery, the binder including a copolymer including a repeating unit represented by Chemical Formula X, a repeating unit represented by Chemical Formula Y-1, a repeating unit represented by Chemical Formula Z, and a repeating unit having a fluoro substituent.

The repeating unit having a fluoro substituent may be a repeating unit represented by one of Chemical Formulae T-1 to T-5,

a weight average molecular weight of the copolymer may be about 10,000 to about 500,000,

a mole ratio of the repeating unit represented by Chemical Formula X may be about 5% to about 35%, a mole ratio of the repeating unit represented by Chemical Formula Y-1 may be about 5% to about 35%, a mole ratio of the repeating unit represented by Chemical Formula Z may be about 20% to about 89.5%, and a mole ratio of the repeating unit having a fluoro substituent may be about 0.5% to about 10%,

[chemical structure]

wherein,

R¹ to R⁴ may each independently be hydrogen, a substituted or unsubstituted C1 to C30 alkyl group, or a substituted or unsubstituted C6 to C30 aryl group,

L may be a substituted or unsubstituted C2 to C10 alkenylene group, and

n may be 0 or 1,

[chemical structure]

wherein,

R⁵ and R⁶ may each independently be hydrogen, or a substituted or unsubstituted C1 to C30 alkyl group, and

R⁷ may be a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group,

[chemical structure]

wherein,

R¹¹ may be hydrogen, or a substituted or unsubstituted C1 to C30 alkyl group, and

R¹² and R¹³ may each independently be hydrogen, a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, or R¹² and R¹³ are linked to each other to form a ring,

[chemical structure]

wherein, R⁴¹, R⁴³, R⁴⁵, R⁴⁷, and R⁵⁰ may each independently be hydrogen, or a substituted or unsubstituted C1 to C30 alkyl group,

R⁴², R⁴⁴, and R⁴⁶ may each independently be a fluoro group, a fluoro-substituted C1 to C30 alkyl group, a fluoro-substituted C2 to C20 alkenyl group, a fluoro-substituted C2 to C20 alkynyl group, a fluoro-substituted C3 to C8 cycloalkyl group, a fluoro-substituted C6 to C30 aryl group, a fluoro-substituted C1 to C30 heteroaryl group, a fluoro-substituted silane group, a fluoro-substituted C1 to C20 alkylsilane group, a fluoro-substituted C1 to C20 alkoxysilane group, or a fluoro-substituted C1 to C20 alkylamine group,

at least one of R⁴⁸ and R⁴⁹ and at least one of R⁵¹ and R⁵² may be a fluoro group, a fluoro-substituted C1 to C30 alkyl group, a fluoro-substituted C2 to C20 alkenyl group, a fluoro-substituted C2 to C20 alkynyl group, a fluoro-substituted C3 to C8 cycloalkyl group, a fluoro-substituted C6 to C30 aryl group, a fluoro-substituted C1 to C30 heteroaryl group, a fluoro-substituted silane group, a fluoro-substituted C1 to C20 alkylsilane group, a fluoro-substituted C1 to C20 alkoxysilane group, or a fluoro-substituted C2 to C20 carbonyl group, or

R⁴⁸ and R⁴⁹ may be linked to each other to form a ring, and R⁵¹ and R⁵² may be linked to each other to form a ring.

The binder for a rechargeable lithium battery may be an aqueous binder.

Embodiments are also directed to an electrode for a rechargeable lithium battery, including a current collector, and an electrode composition disposed on one side or both sides of the current collector, the electrode composition including an active material and a binder.

The binder may include a copolymer including a repeating unit represented by Chemical Formula X, a repeating unit represented by Chemical Formula Y-2, a repeating unit represented by Chemical Formula Z, and a repeating unit having a fluoro substituent,

the repeating unit having a fluoro substituent may be a repeating unit represented by one of Chemical Formulae T-1 to T-5,

a weight average molecular weight of the copolymer may be about 10,000 to about 500,000, and

a mole ratio of the repeating unit represented by Chemical Formula X may be about 5% to about 35%, a mole ratio of the repeating unit represented by Chemical Formula Y-2 may be about 5% to about 35%, a mole ratio of the repeating unit represented by Chemical Formula Z may be about 20% to about 89.5%, and a mole ratio of the repeating unit having a fluoro substituent may be 0.5% to about 10%,

[chemical structure]

wherein,

R¹ to R⁴ may each independently hydrogen, a substituted or unsubstituted C1 to C30 alkyl group, or a substituted or unsubstituted C6 to C30 aryl group,

L may be a substituted or unsubstituted C2 to C10 alkenylene group, and

n may be 0 or 1,

[chemical structure]

wherein,

R⁵ and R⁶ may each independently be hydrogen, or a substituted or unsubstituted C1 to C30 alkyl group,

R⁷ may be a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, and

a mole ratio of Chemical Formula X:Chemical Formula Y-2 may be about 90:10 to about 10:90,

[chemical structure]

wherein,

R¹¹ may be hydrogen, or a substituted or unsubstituted C1 to C30 alkyl group, and

R¹² and R¹³ may each independently be hydrogen, a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, or R¹² and R¹³ may be linked to each other to form a ring,

[chemical structure]

wherein,

R⁴¹, R⁴⁵, R⁴⁷, and R⁵⁰ may each independently be hydrogen, or a substituted or unsubstituted C1 to C30 alkyl group,

R⁴², R⁴⁴, and R⁴⁶ may each independently be a fluoro group, a fluoro-substituted C1 to C30 alkyl group, a fluoro-substituted C2 to C20 alkenyl group, a fluoro-substituted C2 to C20 alkynyl group, a fluoro-substituted C3 to C8 cycloalkyl group, a fluoro-substituted C6 to C30 aryl group, a fluoro-substituted C1 to C30 heteroaryl group, a fluoro-substituted silane group, a fluoro-substituted C1 to C20 alkylsilane group, a fluoro-substituted C1 to C20 alkoxysilane group, or a fluoro-substituted C1 to C20 alkylamine group,

at least one of R⁴⁸ and R⁴⁹ and at least one of R⁵¹ and R⁵² may be a fluoro group, a fluoro-substituted C1 to C30 alkyl group, a fluoro-substituted C2 to C20 alkenyl group, a fluoro-substituted C2 to C20 alkynyl group, a fluoro-substituted C3 to C8 cycloalkyl group, a fluoro-substituted C6 to C30 aryl group, a fluoro-substituted C1 to C30 heteroaryl group, a fluoro-substituted silane group, a fluoro-substituted C1 to C20 alkylsilane group, a fluoro-substituted C1 to C20 alkoxysilane group, or a fluoro-substituted C2 to C20 carbonyl group, or

R⁴⁸ and R⁴⁹ may be linked to each other to form a ring, and R⁵¹ and R⁵² may be linked to each other to form a ring.

The repeating unit represented by Chemical Formula Y-2 may be prepared by heat-treating a repeating structure represented by Chemical Formula Y-1,

[chemical structure]

wherein,

R⁵ and R⁶ may each independently be hydrogen, or a substituted or unsubstituted C1 to C30 alkyl group, and

R⁷ may be a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group.

The active material may include Si, SiOₓ, a Si—C composite, a Si-Q alloy, graphite, or a combination thereof. X may be in the range of 0<x<2, and Q may be an alkali metal, an alkaline-earth metal, a Group 13 to 16 element, a transition element, a rare earth element, or a combination thereof but not Si.

Embodiment are also directed to a method of manufacturing an electrode for a rechargeable lithium battery, the method including mixing an active material, a solvent, and a binder to prepare an electrode composition, coating the electrode composition on a current collector, and heat-treating the current collector coated with the electrode composition.

The binder before heat-treating may include a copolymer including a repeating unit represented by Chemical Formula X, a repeating unit represented by Chemical Formula Y-1, and a repeating unit represented by Chemical Formula Z, and lithium ions,

the binder after heat-treating may include a copolymer including a repeating unit represented by Chemical Formula X, a repeating unit represented by Chemical Formula Y-2, a repeating unit represented by Chemical Formula Z, and a repeating unit having a fluoro substituent,

a weight average molecular weight of the copolymer may be about 10,000 to about 500,000,

a mole ratio of the repeating unit represented by Chemical Formula X may be about 5% to about 35%, a mole ratio of the repeating unit represented by Chemical Formula Y-2 may be about 5% to about 35%, a mole ratio of the repeating unit represented by Chemical Formula Z may be about 20% to about 89.5%, and a mole ratio of the repeating unit having a fluoro substituent may be 0.5% to about 10%,

[chemical structure]

wherein,

R¹ to R⁴ may each independently be hydrogen, a substituted or unsubstituted C1 to C30 alkyl group, or a substituted or unsubstituted C6 to C30 aryl group,

L may be a substituted or unsubstituted C2 to C10 alkenylene group, and

n may be 0 or 1,

[chemical structure]

wherein,

R⁵ and R⁶ may each independently be hydrogen, or a substituted or unsubstituted C1 to C30 alkyl group, and

R⁷ may be a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group,

[chemical structure]

wherein,

R⁵ and R⁶ may each independently be hydrogen, or a substituted or unsubstituted C1 to C30 alkyl group, and

R⁷ may be a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group,

[chemical structure]

wherein,

R¹¹ may be hydrogen, or a substituted or unsubstituted C1 to C30 alkyl group,

R¹² and R¹³ may each independently be hydrogen, a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, or R¹² and R¹³ may be linked to each other to form a ring,

[chemical structure]

wherein,

R⁴¹, R⁴³, R⁴⁵, R⁴⁷, and R⁵⁰ may each independently be hydrogen, or a substituted or unsubstituted C1 to C30 alkyl group,

R⁴², R⁴⁴, and R⁴⁶ may each independently be a fluoro group, a fluoro-substituted C1 to C30 alkyl group, a fluoro-substituted C2 to C20 alkenyl group, a fluoro-substituted C2 to C20 alkynyl group, a fluoro-substituted C3 to C8 cycloalkyl group, a fluoro-substituted C6 to C30 aryl group, a fluoro-substituted C1 to C30 heteroaryl group, a fluoro-substituted silane group, a fluoro-substituted C1 to C20 alkylsilane group, a fluoro-substituted C1 to C20 alkoxysilane group, or a fluoro-substituted C1 to C20 alkylamine group,

at least one of R⁴⁸ and R⁴⁹ and at least one of R⁵¹ and R⁵² may be a fluoro group, a fluoro-substituted C1 to C30 alkyl group, a fluoro-substituted C2 to C20 alkenyl group, a fluoro-substituted C2 to C20 alkynyl group, a fluoro-substituted C3 to C8 cycloalkyl group, a fluoro-substituted C6 to C30 aryl group, a fluoro-substituted C1 to C30 heteroaryl group, a fluoro-substituted silane group, a fluoro-substituted C1 to C20 alkylsilane group, a fluoro-substituted C1 to C20 alkoxysilane group, or a fluoro-substituted C2 to C20 carbonyl group, or

R⁴⁸ and R⁴⁹ may be linked to each other to form a ring, and R⁵¹ and R⁵² may be linked to each other to form a ring.

The heat-treating may be performed at about 120° C. to about 300° C.

The solvent may include water, an alcohol, or a combination thereof.

Embodiments are also directed to a rechargeable lithium battery including an electrode according to an embodiment, a separator, and an electrolyte.

### BRIEF DESCRIPTION OF THE DRAWINGS

Features will become apparent to those of skill in the art by describing in detail exemplary embodiments with reference to the attached drawings in which:

FIG. 1 illustrates a schematic view showing a rechargeable lithium battery according to an embodiment.

FIG. 2 illustrates an infrared (IR) spectrograph of a binder according to heat-treating temperature.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawing figures, the dimensions of layers and regions may be exaggerated for clarity of illustration. Like reference numerals refer to like elements throughout.

As used herein, when a definition is not otherwise provided, the term “substituted” may refer to substitution with a C1 to C10 alkyl group; a C2 to C30 alkenyl group, a C2 to C30 alkynyl group, a C1 to C10 alkylsilyl group; a C3 to C30 cycloalkyl group; a C6 to C30 aryl group; a C1 to C30 heteroaryl group; a C1 to C10 alkoxy group, instead of at least one hydrogen of a compound.

As used herein, when a definition is not otherwise provided, the term “hetero” may refer to one selected from N, O, S, and P.

As used herein, when a definition is not otherwise provided, the term “alkyl group” may refer to “a saturated alkyl group” without any alkenyl group or alkynyl; or “an unsaturated alkyl group” including at least one alkenyl group or alkynyl group. The “alkenyl group” may refer to a substituent having at least one carbon-carbon double bond of at least two carbons, and the “alkyne group” may refer to a substituent having at least one carbon-carbon triple bond of at least two carbons. The alkyl group may be branched, linear, or cyclic.

The alkyl group may be a C1 to C30 alkyl group, for example, a C1 to C6 lower alkyl group, a C7 to C10 medium-sized alkyl group, or a C11 to C30 higher alkyl group. In one embodiment, the alkyl group may be a C1 to C10 alkyl group.

For example, a C1 to C4 alkyl group may have 1 to 4 carbon atoms in an alkyl chain and may be selected from methyl, ethyl, propyl, iso-propyl, n-butyl, iso-butyl, sec-butyl, and t-butyl.

Examples of the alkyl group may be a methyl group, an ethyl group, a propyl group, an isopropyl group, a butyl group, an isobutyl group, a t-butyl group, a pentyl group, a hexyl group, a cyclopropyl group, a cyclobutyl group, a cyclopentyl group, a cyclohexyl group, and the like.

The “aromatic group” may refer to a cyclic substituent including all elements having a p-orbital which form conjugation. Examples of the aromatic group may include an aryl group and a heteroaryl group.

The “aryl group” may refer to a monocyclic or fused ring (i.e., a plurality of rings sharing adjacent pairs of carbon atoms).

The “heteroaryl group” may refer to an aryl group including 1 to 3 hetero atoms selected from the group of N, O, S, and P. When the heteroaryl group is a fused ring, each ring may include 1 to 3 hetero atoms.

As used herein, when a definition is not otherwise provided, the term “copolymerization” may refer to block copolymerization, random copolymerization, graft copolymerization, or alternating copolymerization, and the term “copolymer” may refer to a block copolymer, a random copolymer, a graft copolymer, or an alternating copolymer.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

### Embodiment 1

### Binder for Rechargeable Lithium Battery

In an embodiment, a binder for a rechargeable lithium battery includes a copolymer including a repeating unit represented by Chemical Formula X, a repeating unit represented by Chemical Formula Y-1, and a repeating unit represented by Chemical Formula Z, and lithium ions (Li⁺).

A weight average molecular weight of the copolymer may range from about 10,000 to about 500,000, a mole ratio of the repeating unit represented by Chemical Formula X may range from about 5% to about 35%, a mole ratio of the repeating unit represented by Chemical Formula Y-1 may range from about 5% to about 35%, and a mole ratio of the repeating unit represented by Chemical Formula Z may range from about 30% to about 90%.

[chemical structure]

According to the present example embodiment, in the above Chemical Formula X, R¹ to R⁴ are each independently hydrogen, a substituted or unsubstituted C1 to C30 alkyl group, or a substituted or unsubstituted C6 to C30 aryl group, L is a substituted or unsubstituted C2 to C10 alkenylene group, and n is 0 or 1.

[chemical structure]

According to the present example embodiment, in the above Chemical Formula Y-1, R⁵ and R⁶ are each independently hydrogen, or a substituted or unsubstituted C1 to C30 alkyl group, and

R⁷ is a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group.

The R⁷ may be substituted with at least one functional group selected from a halogen, an amino group, a mercapto group, an ether group, an ester group, a C1 to C20 alkoxy group, a sulfone group, a nitro group, a hydroxy group, a cyclobutene group, a carbonyl group, a carboxyl group, an alkyl group, an urethane group, a vinyl group, a nitrile group, or an epoxy group.

The R⁷ may be specifically selected from a methyl group, an ethyl group, a propyl group, a butyl group, a cyclohexyl group, a monoethanol group, a diethanol group, and the like. In an embodiment, the R⁷ may be a methyl group or an ethyl group. The binder for a rechargeable lithium battery may exhibit good solubility in water.

[chemical structure]

According to the present example embodiment, in the above Chemical Formula Z, R¹¹ is hydrogen, or a substituted or unsubstituted C1 to C30 alkyl group, and R¹² and R¹³ are each independently hydrogen, a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, or R¹² and R¹³ may be linked to each other to form a ring.

The binder may be used with an organic solvent, and also used with an aqueous solvent such as water, alcohols, and the like. The binder may be an organic binder, or also may be an aqueous binder. The binder used with an aqueous solvent may be environmentally-friendly.

A general binder for a rechargeable lithium battery, such as a styrene-butadiene rubber (SBR), carboxymethyl cellulose (CMC), and the like, may a deteriorate cycle-life of a rechargeable lithium battery. In addition, if polyamideimide (PAI) is used as a binder for a rechargeable lithium battery, the binder may decrease initial efficiency of a rechargeable lithium battery and have an unfavorable influence on an environment due to an organic solvent, N-methylpyrrolidone (NMP). Further, a bromine-based compound may be prohibited from being released in the air.

According to the present example embodiment, the binder for a rechargeable lithium battery may endure volume expansion of an active material during the charge and discharge, and thus work as a buffer layer. In addition, the binder may adhere active material particles one another and also the active material to a current collector. Accordingly, a rechargeable lithium battery including the binder may be stable, and may have excellent rate capability and cycle-life characteristics. In addition, the binder may be aqueous and thus environmentally-friendly.

According to the present example embodiment, the copolymer may be formed by randomly or alternately copolymerizing the repeating unit represented by Chemical Formula X, the repeating unit represented by Chemical Formula Y-1, and the repeating unit represented by Chemical Formula Z.

The copolymer may have an interpenetrating polymer network (IPN) formed of a blend of more than two cross-linking polymers or a semi-interpenetrating polymer network (semi-IPN) formed of a blend of a polymer and a linear polymer. Accordingly, the copolymer may have a dense and thick structure, and the binder including the same may better endure expansion of the active material.

According to the present example embodiment, the repeating unit represented by Chemical Formula X is a repeating unit obtained from an ethylene unsaturated monomer. For example, the repeating unit represented by Chemical Formula X may be a functional group obtained from styrene, ethylene, isobutylene, or isoprene. The repeating unit represented by Chemical Formula X may be a repeating unit represented by, e.g., one of Chemical Formulae X-1 to X-4.

[chemical structure]

When the binder includes a repeating unit represented by Chemical Formula X-1 derived from styrene, the binder may effectively suppress volume expansion of an active material.

A mole ratio of the repeating unit represented by Chemical Formula X may range from about 5% to about 35%, e.g., about 5% to about 25%, or about 5% to about 15%, based on 100% of the copolymer. When the mole ratio of the repeating unit represented by Chemical Formula X is within the range, the binder including the same may well endure volume expansion of an active material and help secure sufficient adherence.

According to the present example embodiment, the repeating unit represented by Chemical Formula Y-1 includes an amic acid group. The repeating unit represented by Chemical Formula Y-1 may be converted into a repeating unit including an imide group by drying and heat-treating a copolymer including the repeating unit represented by Chemical Formula Y-1.

A mole ratio of the repeating unit represented by Chemical Formula Y-1 may range from about 5% to about 35%, e.g., about 5% to about 25%, or about 5% to about 15%, based on 100% of the copolymer. When the mole ratio of the repeating unit represented by Chemical Formula Y-1 is within the range, the binder including the same may well endure volume expansion of an active material and help secure sufficient adherence.

A mole ratio of the repeating unit represented by Chemical Formula X: the repeating unit represented by Chemical Formula Y-1 may range about 40:60 to about 60:40, or about 45:55 to about 55:45. The repeating units represented by Chemical Formulae X and Y-1 may be included in almost the same ratio. The ratio is a relative mole ratio between the repeating units represented by Chemical Formulae X and Y-1 based on the sum of the repeating units represented by Chemical Formulae X and Y-1. When the mole ratio is within the range, the binder may be more soluble in water and may provide stronger adherence.

According to the present example embodiment, the repeating unit represented by Chemical Formula Z is a repeating unit having an amide group. The repeating unit represented by Chemical Formula Z may be, e.g., a repeating unit derived from N-substituted or unsubstituted acrylamide.

A mole ratio of the repeating unit represented by Chemical Formula Z may range from about 30% to about 90%, e.g., about 40% to about 90% or about 50% to about 90%, based on 100% of the copolymer. When the mole ratio of the repeating unit represented by Chemical Formula Z is within the range, the binder including the same may well endure volume expansion of an active material and help secure sufficient adherence.

The binder for a rechargeable lithium battery may help improve rate capability of a rechargeable lithium battery due to lithium ions (Li⁺). The lithium ions may ion-bonded with an atom having large electron affinity such as oxygen, nitrogen, and the like of the copolymer of the binder, or may be present in a hydrated ion state without such a bond with the copolymer.

An amount of the lithium ions may range from about 0.1 moles to 10 moles, e.g., about 0.3 moles to about 8 moles or about 0.3 moles to about 7 moles, based on 100 moles of the copolymer. When the lithium ions are included within the range, rate capability of rechargeable lithium battery may be improved.

The lithium ions may be included in the copolymer by, e.g., adding a lithium compound such as lithium hydroxide (LiOH), lithium carbonate (Li₂CO₃), and the like during preparation of the copolymer.

The copolymer may have a weight average molecular weight of about 10,000 to about 500,000, e.g., about 100,000 to about 400,000. The binder for a rechargeable lithium battery may have a different viscosity and adherence depending on its molecular weight. When the aqueous binder has a weight average molecular weight within the range, workability during preparation of electrode slurry and adherence of the electrode slurry to a current collector may be improved.

According to an example embodiment, the binder for a rechargeable lithium battery may be prepared by, for example, reacting a substituted or unsubstituted ethylene monomer, a substituted or unsubstituted maleic anhydride, and a substituted or unsubstituted amine, and then adding an acrylamide monomer and lithium hydroxide.

According to an example embodiment, the copolymer may further include at least one of repeating structures represented by Chemical Formulae W-1 to W-5.

[chemical structure]

According to the present example embodiment, in the above Chemical Formulae W-1 to W-5, R²¹, R²³, R²⁵, R²⁷, and R³⁰ are each independently hydrogen, or a substituted or unsubstituted C1 to C30 alkyl group.

In the above Chemical Formulae W-1 to W-3, R²², R²⁴, and R²⁶ are each independently hydrogen, a substituted or unsubstituted C1 to C30 alkyl group, a substituted or unsubstituted C2 to C20 alkenyl group, a substituted or unsubstituted C2 to C20 alkynyl group, a substituted or unsubstituted C3 to C8 cycloalkyl group, a substituted or unsubstituted C6 to C30 aryl group, a substituted or unsubstituted C1 to C30 heteroaryl group, a silane group, a C1 to C20 alkylsilane group, a C1 to C20 alkoxysilane group, or a C1 to C20 alkylamine group.

In the above Chemical Formulae W-4 and W-5, R²⁸, R²⁹, R³¹, and R³² are each independently hydrogen, a substituted or unsubstituted C1 to C30 alkyl group, a substituted or unsubstituted C2 to C20 alkenyl group, a substituted or unsubstituted C2 to C20 alkynyl group, a C3 to C8 cycloalkyl group, a substituted or unsubstituted C6 to C30 aryl group, a substituted or unsubstituted C1 to C30 heteroaryl group, a silane group, a C1 to C20 alkylsilane group, a C1 to C20 alkoxysilane group, or a C2 to C20 carbonyl group, and may include a heteroatom.

R²⁸ and R²⁹ may be linked to each other to form a ring, and R³¹ and R³² may be linked to each other to form a ring. In Chemical Formula W-4, N, R²⁸, and R²⁹ may be linked to form a 5-membered ring, 6-membered ring, 7-membered ring, and the like, and in Chemical Formula W-5, N, R³¹, and R³² are linked to form a 5-membered ring, 6-membered ring, 7-membered ring. Such rings may be, e.g., fused.

The copolymer may have improved adherence due to the repeating units represented by Chemical Formulae W-1 to W-5.

In an example embodiment, the copolymer may include at least one of repeating structures represented by Chemical Formulae V-1 to V-3. Chemical Formulae V-1 to V-3 are examples of the above Chemical Formulae W-1 to W-5. The Chemical Formulae V-1 and V-2 are examples of Chemical Formula W-1, and Chemical Formula V-3 is an example of Chemical Formula W-4.

[chemical structure]

Electrode for Rechargeable Lithium Battery

According to an example embodiment, an electrode for a rechargeable lithium battery includes a current collector and an electrode composition disposed on one side or both sides of the current collector. According to the present example embodiment, the electrode composition includes an active material and a binder, and the binder includes a copolymer including a repeating unit represented by Chemical Formula X, a repeating unit represented by Chemical Formula Y-2, and a repeating unit represented by Chemical Formula Z, and lithium ions (Li⁺).

According to the present example embodiment, a weight average molecular weight of the copolymer may range from about 10,000 to about 500,000, a mole ratio of the repeating unit represented by Chemical Formula X may range from about 5% to about 35%, a mole ratio of the repeating unit represented by Chemical Formula Y-2 may range from about 5% to about 35%, and a mole ratio of the repeating unit represented by Chemical Formula Z may range from about 30% to about 90%.

According to the present example embodiment, Chemical Formula X, Chemical Formula Z, and the lithium ions are as described above.

[chemical structure]

According to the present example embodiment, in the above Chemical Formula Y-2, R⁵ and R⁶ are each independently hydrogen, or a substituted or unsubstituted C1 to C30 alkyl group.

R⁷ is a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group.

The R⁷ may be substituted with at least one functional group selected from a halogen, an amino group, a mercapto group, an ether group, an ester group, a C1 to C20 alkoxy group, a sulfone group, a nitro group, a hydroxy group, a cyclobutene group, a carbonyl group, a carboxyl group, an alkyl group, an urethane group, a vinyl group, a nitrile group, or an epoxy group.

The R⁷ may be, e.g., a methyl group, an ethyl group, a propyl group, a butyl group, a cyclohexyl group, a monoethanol group, or a diethanol group. In an embodiment, the R⁷ may be a methyl group or an ethyl group. The binder for a rechargeable lithium battery may be soluble in water.

The binder may be used with an organic solvent, and also used with an aqueous solvent such as water, alcohols, and the like. The binder may be an organic binder, or also may be an aqueous binder. The binder used with an aqueous solvent may be environmentally-friendly.

The electrode for a rechargeable lithium battery may be capable of enduring volume expansion of an active material during charge and discharge of a rechargeable lithium battery, and a rechargeable lithium battery including the same may be stable, and have improved rate capability and cycle-life characteristics.

The copolymer may be formed by randomly or alternately copolymerizing the repeating unit represented by Chemical Formula X, the repeating unit represented by the above Chemical Formula Y-2, and the repeating unit represented by Chemical Formula Z.

According to the present example embodiment, the repeating unit represented by the above Chemical Formula Y-2 is a repeating unit having an imide group, and may be formed by drying and heat-treating the binder including the repeating unit represented by Chemical Formula Y-1.

The binder in the electrode composition may be a binder obtained by heat-treating the binder for a rechargeable lithium battery.

A mole ratio of the repeating unit represented by Chemical Formula Y-2 may range from about 5% to about 35%, e.g., about 5% to about 25% or about 5% to about 15%. When such a mole ratio of the repeating unit represented by Chemical Formula Y-1, the binder including the same may well endure volume expansion of an active material and help secure sufficient adherence.

A mole ratio of the repeating unit represented by Chemical Formula X: repeating unit represented by Chemical Formula Y-2 may be in a range of about 40:60 to about 60:40, or about 45:55 to about 55:45. The repeating units represented by Chemical Formulae X and Y-2 may be included in almost the same ratio. The ratio is a relative mole ratio between the repeating units represented by Chemical Formulae X and Y-2 based on the sum of the repeating units represented by Chemical Formulae X and Y-2. When the mole ratio is within the range, the binder may be more soluble in water and may have stronger adherence.

The copolymer may further include at least one of repeating structures represented by Chemical Formulae W-1 to W-5. The Chemical Formulae W-1 to W-5 and their description are as described above.

In an example embodiment, the copolymer may include at least one of Chemical Formula V-1 to V-3. The Chemical Formulae V-1 to V-3 are examples of the above Chemical Formulae W-1 to W-5. The Chemical Formulae V-1 and V-2 are examples of Chemical Formula W-1, and Chemical Formula V-3 is an example of Chemical Formula W-4. The Chemical Formula V-1 to Chemical Formula V-3 and their description are as described above.

In the electrode for a rechargeable lithium battery, the binder may be included in an amount of about 0.01 to about 50 wt %, e.g., about 1 to about 30 wt %, about 1 to about 20 wt %, about 3 to about 20 wt %, or about 1 to about 10 wt %, based on 100 wt % of the electrode composition. When the binder is included within the range, an electrode for a rechargeable lithium battery including the binder may well endure volume expansion of an active material and help secure sufficient adherence.

According to the present example embodiment, the active material may include Si, SiOₓ, a Si—C composite, a Si-Q alloy, graphite, or a combination thereof. The x is in the range of 0<x<2, and Q is an alkali metal, an alkaline-earth metal, a Group 13 to 16 element, a transition element, a rare earth element, or a combination thereof but not Si. Specific examples of Q may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, Ni, Mn, or a combination thereof.

When the active material is applied to a rechargeable lithium battery, the rechargeable lithium battery may have high-capacity. The active material may be expanded about 300% to about 400% during the charge and discharge, and may deteriorate stability or cycle-life characteristic of a rechargeable lithium battery. When the active material is used with the binder according to an embodiment, the binder may well endure expansion of the active material and work as a buffer layer. Accordingly, a rechargeable lithium battery including the binder may be stable and have excellent cycle-life characteristics.

When a binder such as styrene-butadiene rubber (SBR), carboxymethyl cellulose (CMC), and the like is applied to a negative electrode, a negative active material including greater than or equal to about 5 wt % of Si may not realize a desirable level of performance of a rechargeable lithium battery. When the Si is included in an amount of about 3 wt % or about 1.6 wt %, the negative active material may deteriorate a cycle-life characteristic of a rechargeable lithium battery. However, the binder according to an example embodiment may bring about excellent cycle-life characteristics and efficiency of a rechargeable lithium battery when Si is included in an amount of greater than or equal to about 5 wt %, as well as in a small amount.

In an example embodiment, the electrode composition may further include a conductive material.

The conductive material may help improve electrical conductivity of the negative electrode. A suitable electrically conductive material that does not a chemical change may be used. Examples of the conductive material may include at least one selected from a carbon-based material of natural graphite, artificial graphite, carbon black, acetylene black, ketjen black, a carbon fiber, and the like; a metal-based material such as a metal powder or a metal fiber including copper, nickel, aluminum, silver, and the like; a conductive a polymer such as a polyphenylene derivative; or a mixture thereof

The conductive material may be used in an amount of about 0.1 parts by weight to about 50 parts by weight, e.g., about 0.1 parts by weight to about 30 parts by weight, about 0.1 parts by weight to about 15 parts by weight, or about 0.1 parts by weight to about 10 parts by weight, based on 100 parts by weight of the electrode composition.

The electrode composition may further include a thickener. Herein, the thickener may effectively control phase separation of an active material in a slurry state and help secure stability of an electrode composition.

The thickener may include, e.g., polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

When the thickener is included in the electrode composition, the thickener may be included in an amount of more than about 0 or equal to about 10 parts by weight, e.g., more than about 0 and less than or equal to about 3 parts by weight, based on 100 parts by weight of the electrode composition.

The electrode for a rechargeable lithium battery may be a negative electrode. The electrode composition may be a negative electrode composition, and the active material may be a negative active material.

When the binder according to an embodiment is applied with a negative active material including silicon (Si) to fabricate a negative electrode, improved effects may be expected. The binder may also be applied to a positive electrode as well as the negative electrode.

In addition, the current collector may be a suitable current collector that does not cause a chemical change and has high conductivity. The current collector may be, e.g., about 3 μm to about 500 μm thick.

The current collector applied to a negative electrode may be, e.g., a copper foil, a nickel foil, a stainless steel foil, a titanium foil, a nickel foam, a copper foam, a polymer substrate coated with a conductive metal, and combinations thereof.

The current collector applied to a positive electrode may be, e.g., a stainless steel, aluminum, nickel, titanium, fired carbon, or aluminum or stainless steel that is surface-treated with carbon, nickel, titanium, silver, and the like.

Manufacturing Method of Electrode for Rechargeable Lithium Battery

According to another example embodiment, a method of manufacturing the electrode for a rechargeable lithium battery includes mixing an active material, a solvent, and a binder according to an embodiment to prepare an electrode composition, coating the electrode composition on a current collector, and heat-treating the current collector coated with the electrode composition.

The binder before heat-treating may include the copolymer including the repeating unit represented by Chemical Formula X, the repeating unit represented by Chemical Formula Y-1, and the repeating unit represented by Chemical Formula Z, and lithium ions (Li⁺).

The binder after heat-treating may include the copolymer including the repeating unit represented by Chemical Formula X, the repeating unit represented by Chemical Formula Y-2, and the repeating unit represented by Chemical Formula Z, and lithium ions (Li⁺).

A weight average molecular weight of the copolymer may range from about 10,000 to about 500,000.

A mole ratio of the repeating unit represented by Chemical Formula X may range from about 5% to about 35%, a mole ratio of the repeating unit represented by Chemical Formula Y-2 may range from about 5% to about 35%, a mole ratio of the repeating unit represented by Chemical Formula Z may range from about 30% to about 90%.

The Chemical Formula X, Chemical Formula Y-1, Chemical Formula Y-2, and Chemical Formula Z are as described above.

The binder before heat-treating may be prepared by, e.g., reacting a substituted or unsubstituted ethylene monomer, a substituted or unsubstituted maleic anhydride, and a substituted or unsubstituted amine, and then adding an acrylamide monomer and a lithium compound.

In the manufacturing method, the repeating unit represented by Chemical Formula Y-1 may be converted into the repeating unit represented by Chemical Formula Y-2 by the heat-treating.

According to the present example embodiment, an electrode for a rechargeable lithium battery in the manufacturing method may well endure volume expansion of an active material during the charge and discharge, and may have excellent adherence among active material particles or the active material to a current collector, which may help provide a rechargeable lithium battery having excellent stability, rate capability, and cycle-life characteristics.

The solvent may be an organic solvent, e.g., an aqueous solvent. The aqueous solvent may be a general aqueous solvent, e.g., the solvent may include water, alcohols, or a combination. In an implementation, the solvent is water alone. The manufacturing method using the aqueous solvent may be environmentally-friendly.

In the manufacturing method of the electrode for a rechargeable lithium battery, the heat-treating may be performed at about 120° C. to about 300° C., e.g., about 120° C. to about 250° C., about 120° C. to about 200° C., about 150° C. to about 300° C., about 150° C. to about 250° C., or about 150° C. to about 200° C. The heat-treating within these temperature ranges may convert a repeating unit represented by Chemical Formula Y-1 into a repeating unit represented by Chemical Formula Y-2. Thus, an amic acid group may be converted into an imide group.

FIG. 2 illustrates an infrared (IR) spectrograph of a binder according to heat-treating temperature. Referring to FIG. 2, when the binder is heat-treated at 110° C., the binder has no peak at 1700 cm⁻¹ which is an absorption region of imide. However, when the binder is heat-treated at greater than or equal to the temperature, the peak is clearly observed.

The heat-treating may be performed for about 10 minutes to about 5 hours, e.g., about 3 hours, or about 30 minutes to about 2 hours. Under the heat-treating condition, a repeating unit represented by Chemical Formula Y-1 may be converted into a repeating unit represented by Chemical Formula Y-2.

The heat-treating may be performed in the air, or under an inert gas atmosphere or a vacuum atmosphere. In an implementation, the heat-treating is performed under the vacuum atmosphere.

The copolymer may further include at least one of repeating structures represented by Chemical Formulae W-1 to W-5. During preparation of the binder, a monomer deriving the repeating unit represented by Chemical Formulae W-1 to W-5 may be further added. The Chemical Formulae W-1 to W-5 are as described above.

The copolymer may further include at least one of repeating structures represented by Chemical Formulae V-1 to V-3. Chemical Formulae V-1 to V-3 are examples of Chemical Formulae W-1 to W-5. Chemical Formulae V-1 and V-2 are examples of Chemical Formula W-1, and Chemical Formula V-3 is an example of Chemical Formula W-4. Chemical Formula V-1 to Chemical Formula V-3 are as described above.

In the method of manufacturing an electrode for a rechargeable lithium battery, the binder may be used in an amount of about 0.01 to about 50 wt %, e.g., about 1 to about 30 wt %, about 1 to about 20 wt %, about 3 to about 20 wt %, or about 1 to about 10 wt %, based on 100 wt % of the electrode composition. When the binder is included within the range, an electrode for a rechargeable lithium battery fabricated in the manufacturing method may well endure volume expansion of an active material and help secure sufficient adherence.

According to the present example embodiment, the active material may include Si, SiOₓ, a Si—C composite, a Si-Q alloy, graphite, or a combination thereof, in which the x is in the range of 0<x<2, and Q is an alkali metal, an alkaline-earth metal, a Group 13 to 16 element, a transition element, a rare earth element, or a combination thereof but not Si. Specific examples of Q may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, Ni, Mn, or a combination thereof.

The active material may provide a rechargeable lithium battery having high-capacity. Generally, an active material may be about 300 to about 400% expanded during the charge and discharge, which may deteriorate stability or cycle-life characteristics of a battery. When the active material is used with the binder according to an embodiment, the binder may well endure expansion of the active material and work as a buffer layer. Accordingly, a rechargeable lithium battery including the binder may be stable and have excellent cycle-life characteristic.

In the manufacturing method of the electrode for a rechargeable lithium battery, the current collector is the same as described above.

Rechargeable Lithium Battery

In an example embodiment, a rechargeable lithium battery including the electrode for a rechargeable lithium battery, a separator, and an electrolyte is provided. In another example embodiment, a rechargeable lithium battery including the electrode for a rechargeable lithium battery manufactured according to the method according to an embodiment, a separator, and an electrolyte is provided.

The electrode for a rechargeable lithium battery manufactured according to the method according to an embodiment may be a positive electrode or negative electrode. When the electrode is a negative electrode, improved effect may be expected. In another implementation, the electrode may be a positive electrode.

FIG. 1 illustrates a schematic view of a structure of a rechargeable lithium battery according to an example embodiment. In the example embodiment shown in FIG. 1, the rechargeable lithium battery 1 includes a positive electrode 3, a negative electrode 2, and a separator 4 interposed between the positive electrode 3 and negative electrode 2, an electrolyte impregnated therein, a battery case 5 including the foregoing members, and a sealing member 6 sealing the battery case 5.

When the electrode according to an embodiment is a negative electrode, the positive electrode may include a positive active material that is a compound capable of intercalating and deintercalating lithium, e.g., a lithiated intercalation compound.

The positive active material may be, e.g., a lithium composite oxide including at least one metal selected from cobalt, manganese, nickel, or a combination thereof, and may include one or more of the compounds represented by the following chemical formulae: LiₐA_{1-b}R_{b}D₂ (0.90≦a≦1.8 and 0≦b≦0.5); LiₐE_{1-b}R_{b}O_{2-c}D_{c} (0.90≦a≦1.8, 0≦b≦0.5 and 0≦c≦0.05); LiE_{2-b}R_{b}O_{4-c}D_{c} (0≦b≦0.5, 0≦c≦0.05); LiₐNi_{1-b-c}Co_{b}R_{c}D_{α} (0.90≦a≦1.8, 0≦b≦0.5, 0≦c≦0.05 and 0<α≦2); LiₐNi_{1-b-c}Co_{b}R_{c}O_{2-α}Z₂ (0.90≦a≦1.8, 0≦b≦0.5, 0≦c≦0.05 and 0<α<2); LiₐNi_{1-b-c}Co_{b}R_{c}O_{2-α}Z₂ (0.90≦a≦1.8, 0≦b≦0.5, 0≦c≦0.05 and 0<α<2); LiₐNi_{1-b-c}Mn_{b}R_{c}D_{α} (0.90≦a≦1.8, 0≦b≦0.5, 0≦c≦0.05 and 0<α≦2); LiₐNi_{1-b-c}Mn_{b}R_{c}O_{2-α}Z_{α} (0.90≦a≦1.8, 0≦b≦0.5, 0≦c≦0.05 and 0<α<2); LiₐNi_{1-b-c}Mn_{b}R_{c}O_{2-α}Z₂ (0.90≦a≦1.8, 0≦b≦0.5, 0≦c≦0.05 and 0<α<2); LiₐNi_{b}E_{c}G_{d}O₂ (0.90≦a≦1.8, 0≦b≦0.9, 0≦c≦0.5 and 0.001≦d≦0.1); LiₐNi_{b}Co_{c}Mn_{d}GeO₂ (0.90≦a≦1.8, 0≦b≦0.9, 0≦c≦0.5, 0≦d≦0.5 and 0.001≦e≦0.1); LiₐNiG_{b}O₂ (0.90≦a≦1.8 and 0.001≦b≦0.1); LiₐCoG_{b}O₂ (0.90≦a≦1.8 and 0.001≦b≦0.1); LiₐMnG_{b}O₂ (0.90≦a≦1.8 and 0.001≦b≦0.1); LiₐMn₂G_{b}O₄ (0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

The positive electrode may further include a binder, a conductive material, or a combination thereof. The binder may be, e.g., the binder described above, polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, etc.

The conductive material and current collector are as described above.

The negative electrode and the positive electrode may be manufactured by a method including, e.g., mixing an active material, a binder, or the like in a solvent to prepare an electrode composition, and coating the electrode composition on a current collector. The electrode manufacturing method may be a general method.

The separator may include suitable materials for use in a lithium battery that separate a negative electrode from a positive electrode and provide a transporting passage of lithium ion. The separator may have a low resistance to ion transport and an excellent impregnation for electrolyte. For example, the selector may include glass fiber, polyester, TEFLON (tetrafluoroethylene), polyethylene, polypropylene, polytetrafluoroethylene (PTFE), or a combination thereof. The separator may have a form of a non-woven fabric or a woven fabric. For example, for the lithium ion battery, a polyolefin-based polymer separator such as polyethylene, polypropylene, or the like may be used. To help provide heat resistance and/or mechanical strength, a coated separator including a ceramic component or a polymer material may be used. In an implementation, the separator may have a mono-layered or multi-layered structure.

According to the present example embodiment, the electrolyte includes a non-aqueous organic solvent and a lithium salt.

The non-aqueous organic solvent serves as a medium for transmitting ions taking part in the electrochemical reaction of a battery.

The non-aqueous organic solvent may include, e.g., a carbonate-based, ester-based, ether-based, ketone-based, alcohol-based, or aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), a combination thereof, etc. The ester-based solvent may include methyl acetate, ethyl acetate, n-propyl acetate, 1,1-dimethylethyl acetate, methylpropanoate, ethylpropanoate, γ-butyrolactone, decanolide, valerolactone, mevalonolactone, caprolactone, a combination thereof, etc. The ether-based solvent may include dibutyl ether, tetraglyme, diglyme, dimethoxyethane, 2-methyltetrahydrofuran, tetrahydrofuran, a combination thereof, etc., and the ketone-based solvent may include cyclohexanone, etc. The alcohol-based solvent may include ethanol, isopropyl alcohol, a combination thereof, etc. The aprotic solvent may include nitriles such as R—CN (wherein R is a C2 to C20 linear, branched, or cyclic hydrocarbon group, and may include a double bond, an aromatic ring, or an ether bond), amides such as dimethylformamide, dioxolanes such as 1,3-dioxolane, sulfolanes, a combination thereof, etc.

The non-aqueous organic solvent may be used singularly or in a mixture. When the organic solvent is used in a mixture, its mixture ratio may be determined so as to provide desirable performance of a battery.

The carbonate-based solvent may include, e.g., a mixture of a cyclic carbonate and a linear carbonate. For example, the cyclic carbonate and the linear carbonate may be mixed together in a volume ratio of about 1:1 to about 1:9, which may enhance performance of the electrolyte.

The non-aqueous organic solvent may include a mixture of the carbonate-based solvent and an aromatic hydrocarbon-based organic solvent. In an implementation, the carbonate-based solvent and the aromatic hydrocarbon-based organic solvent are mixed together in a volume ratio of about 1:1 to about 30:1.

The aromatic hydrocarbon-based organic solvent may be an aromatic hydrocarbon-based compound represented by Chemical Formula A.

[chemical structure]

According to an example embodiment, in Chemical Formula A, R₁ to R₆ are each independently hydrogen, a halogen, a C1 to C30 alkyl group, a C1 to C10 haloalkyl group, or a combination thereof

The aromatic hydrocarbon-based organic solvent may be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof

The non-aqueous electrolyte may include vinylene carbonate or an ethylene carbonate-based compound represented by Chemical Formula B, which may help improve a cycle-life of a battery.

[chemical structure]

According to an example embodiment, in Chemical Formula B, R₇ and R₈ are each independently hydrogen, a halogen, a cyano group (CN), a nitro group (NO₂) or a C1 to C5 fluoroalkyl group, provided that at least one of R₇ and R₈ is a halogen, a cyano group (CN), a nitro group (NO₂) or a C1 to C5 fluoroalkyl group.

Examples of the ethylene carbonate-based compound include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The amount of the vinylene carbonate or the ethylene carbonate-based compound may be adjusted within an appropriate range and may help improve cycle life.

The lithium salt is dissolved in the non-aqueous solvent and supplies lithium ions in a rechargeable lithium battery, so as to help operate the rechargeable lithium battery and improve lithium ions transfer between positive and negative electrodes. The lithium salt may include at least one supporting salt selected from LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (wherein, x and y are natural numbers), LiCl, LiI, LiB(C₂O₄)₂ (lithium bis(oxalato) borate, LiBOB), or a combination thereof. The lithium salt may be used in a concentration of about 0.1 to about 2.0M. When the lithium salt is included within the above concentration range, it may help improve electrolyte performance and lithium ions mobility by adjusting electrolyte conductivity and viscosity.

### Embodiment 2

### Binder for Rechargeable Lithium Battery

In another example embodiment, a binder for a rechargeable lithium battery includes a copolymer including a repeating unit represented by Chemical Formula X, a repeating unit represented by Chemical Formula Y-1, a repeating unit represented by Chemical Formula Z, and a repeating unit having a fluoro (F) substituent.

The repeating unit having a fluoro (F) substituent may be a repeating unit represented by one of Chemical Formulae T-1 to T-5.

A weight average molecular weight of the copolymer may range from about 10,000 to about 500,000,

A mole ratio of the repeating unit represented by Chemical Formula X may range from about 5% to about 35%, a mole ratio of the repeating unit represented by Chemical Formula Y-1 may range from about 5% to about 35%, a mole ratio of the repeating unit represented by Chemical Formula Z may range from about 20% to about 89.5%, and the mole ratio of the repeating unit having a fluoro (F) substituent may range from about 0.5% to about 10%.

The Chemical Formula X, Chemical Formula Y-1, Chemical Formula Z, and description thereof are as described above.

[chemical structure]

According to the present example embodiment, in the above Chemical Formulae T-1 to T-5, R⁴¹, R⁴³, R⁴⁵, R⁴⁷, and R⁵⁰ are each independently hydrogen, or a substituted or unsubstituted C1 to C30 alkyl group.

In the above Chemical Formulae T-1 to T-3, R⁴², R⁴⁴, and R⁴⁶ are each independently a fluoro group (F), a fluoro-substituted C1 to C30 alkyl group, a fluoro-substituted C2 to C20 alkenyl group, a fluoro-substituted C2 to C20 alkynyl group, a fluoro-substituted C3 to C8 cycloalkyl group, a fluoro-substituted C6 to C30 aryl group, a fluoro-substituted C1 to C30 heteroaryl group, a fluoro-substituted silane group, a fluoro-substituted C1 to C20 alkylsilane group, a fluoro-substituted C1 to C20 alkoxysilane group, or a fluoro-substituted C1 to C20 alkylamine group.

In the above Chemical Formulae T-4 and T-5, at least one of R⁴⁸ and R⁴⁹ and at least one of R⁵¹ and R⁵² are a fluoro group, a fluoro-substituted C1 to C30 alkyl group, a fluoro-substituted C2 to C20 alkenyl group, a fluoro-substituted C2 to C20 alkynyl group, a fluoro-substituted C3 to C8 cycloalkyl group, a fluoro-substituted C6 to C30 aryl group, a fluoro-substituted C1 to C30 heteroaryl group, a fluoro-substituted silane group, a fluoro-substituted C1 to C20 alkylsilane group, a fluoro-substituted C1 to C20 alkoxysilane group, or a fluoro-substituted C2 to C20 carbonyl group.

R⁴⁸ and R⁴⁹ may be linked to each other to form a ring, and R⁵¹ and R⁵² may be linked to each other to form a ring. In the above Chemical Formula T-4, R⁴⁸ and R⁴⁹ may be linked to form a 5-membered ring, 6-membered ring, 7-membered ring, and the like, and in the above Chemical Formula T-5, R⁵¹ and R⁵² may be linked to form a 5-membered ring, 6-membered ring, 7-membered ring, and the like.

The binder may be used with an organic solvent, and also used with an aqueous solvent such as water, alcohols, and the like. The binder may be an organic binder, or also may be an aqueous binder. The binder may be environmentally-friendly when it is used together with the aqueous solvent.

The binder for a rechargeable lithium battery according to an example embodiment may endure volume expansion of an active material during the charge and discharge, and thus work as a buffer layer. In addition, the binder may adhere active material particles to one another, and adhere the active material to a current collector. The rechargeable lithium battery including the binder may be stable and may exhibit excellent rate capability and cycle-life characteristics.

The copolymer may be formed by, e.g., randomly or alternately copolymerizing the repeating unit represented by Chemical Formula X, the repeating unit represented by Chemical Formula Y-1, the repeating unit represented by Chemical Formula Z, and the repeating unit having a fluoro (F) substituent.

The copolymer may have an interpenetrating polymer network (IPN) formed of a blend of more than two cross-linking polymers or a semi-interpenetrating polymer network (semi-IPN) formed of a blend of a polymer and a linear polymer. Accordingly, the copolymer may have a dense and thick structure, and the binder for a rechargeable lithium battery including the same may better endure expansion of the active material.

The repeating unit represented by Chemical Formula X may be, e.g., a repeating unit represented by one of Chemical Formulae X-1 to X-4. The Chemical Formula X-1 to Chemical Formula X-4 are as described above.

A mole ratio of the repeating unit represented by Chemical Formula X may range from about 5% to about 35%, e.g., about 5% to about 25%, or about 5% to about 15%, based on 100% of the copolymer. When the mole ratio of the repeating unit represented by Chemical Formula X is within the range, the binder including the same may well endure volume expansion of an active material and help secure sufficient adherence.

A mole ratio of the repeating unit represented by Chemical Formula Y-1 may range from about 5% to about 35%, e.g., about 5% to about 25%, or about 5% to about 15%, based on 100% of the copolymer. When the mole ratio of the repeating unit represented by Chemical Formula Y-1 is within the range, the binder including the same may well endure volume expansion of an active material and help secure sufficient adherence.

A mole ratio of the repeating unit represented by Chemical Formula X: repeating unit represented by Chemical Formula Y-1 may range from about 40:60 to about 60:40, or about 45:55 to about 55:45. The repeating units represented by Chemical Formulae X and Y-1 may be included in almost the same ratio. The ratio is a relative mole ratio between the repeating units represented by Chemical Formulae X and Y-1 based on the sum of the repeating units represented by Chemical Formulae X and Y-1. When the mole ratio is within the range, the binder may be more soluble in water and have stronger adherence.

A mole ratio of the repeating unit represented by Chemical Formula Z may range from about 20% to about 89.5%, e.g., about 30% to about 89.5%, or about 40% to about 90%, based on 100% of the copolymer. When the mole ratio of the repeating unit represented by Chemical Formula Z is within the range, the binder including the same may well endure volume expansion of an active material and help secure sufficient adherence.

A mole ratio of the repeating unit having a fluoro (F) substituent may range from about 0.5% to about 10%, e.g., about 0.5% to about 5%, or about 1% to about 5%, based on 100% of the copolymer.

The copolymer may help improve rate capability of a rechargeable lithium battery due to the repeating unit having a fluoro (F) substituent.

An example of the repeating unit having a fluoro (F) substituent may be represented by Chemical Formula T-11.

[chemical structure]

The copolymer may include, e.g., one or more of the repeating structures represented by Chemical Formulae W-1 to W-5. The Chemical Formulae W-1 to W-5 are as described above. Herein, repeating units represented by Chemical Formulae W-1 to W-5 may be a repeating unit unsubstituted with a fluoro group.

The copolymer may have a weight average molecular weight of about 10,000 to about 500,000, e.g., about 100,000 to about 400,000. The binder for a rechargeable lithium battery may have a different viscosity and adherence depending on its molecular weight. When the aqueous binder has a weight average molecular weight within the range, workability during preparation of electrode slurry and adherence of the electrode slurry to a current collector may be improved.

The binder for a rechargeable lithium battery may be prepared, for example, by reacting a substituted or unsubstituted ethylene monomer, a substituted or unsubstituted maleic anhydride, and a substituted or unsubstituted amine, and then adding an acrylamide monomer and a monomer having a fluoro substituent.

Electrode for Rechargeable Lithium Battery

In another example embodiment, an electrode for a rechargeable lithium battery includes a current collector and an electrode composition disposed on one side or both sides of the current collector, wherein the electrode composition includes an active material and a binder, and the binder includes a copolymer including a repeating unit represented by Chemical Formula X, a repeating unit represented by Chemical Formula Y-2, a repeating unit represented by Chemical Formula Z, and a repeating unit having a fluoro (F) substituent.

The repeating unit having a fluoro (F) substituent may be a repeating unit represented by one of Chemical Formulae T-1 to T-5.

A weight average molecular weight of the copolymer may range from about 10,000 to about 500,000.

A mole ratio of the repeating unit represented by Chemical Formula X may range from about 5% to about 35%, a mole ratio of the repeating unit represented by Chemical Formula Y-2 may range from about 5% to about 35%, a mole ratio of the repeating unit represented by Chemical Formula Z may range from about 20% to about 89.5%, and a mole ratio of the repeating unit having a fluoro (F) substituent may range from about 0.5% to about 10%.

Chemical Formula X, Chemical Formula Y-2, Chemical Formula Z, and the repeating unit having a fluoro substituent are as described above.

The electrode for a rechargeable lithium battery may be capable of enduring volume expansion of an active material during charge and discharge of a rechargeable lithium battery, and a rechargeable lithium battery including the same may be stable and have improved rate capability and cycle-life characteristics.

The copolymer may be formed by, e.g., randomly or alternately copolymerizing the repeating unit represented by Chemical Formula X, the repeating unit represented by the above Chemical Formula Y-2, the repeating unit represented by Chemical Formula Z, and the repeating unit having a fluoro substituent.

According to the present example embodiment, the repeating unit represented by the above Chemical Formula Y-2 is a repeating unit having an imide group, and is formed by drying and heat-treating the binder including the repeating unit represented by Chemical Formula Y-1.

According to the present example embodiment, the binder in the electrode composition is obtained by heat-treating the binder for a rechargeable lithium battery.

A mole ratio of the repeating unit represented by Chemical Formula Y-2 may range from about 5% to about 35%, e.g., about 5% to about 25%, or about 5% to about 15%. When the mole ratio of the repeating unit represented by Chemical Formula Y-1 is as described, the binder including the same may well endure volume expansion of an active material and help secure sufficient adherence.

A mole ratio of the repeating unit represented by Chemical Formula X: repeating unit represented by Chemical Formula Y-2 may range from about 40:60 to about 60:40, or about 45:55 to about 55:45. The repeating units represented by Chemical Formulae X and Y-2 may be included in almost the same ratio. The ratio is a relative mole ratio between the repeating units represented by Chemical Formulae X and Y-2 based on the sum of the repeating units represented by Chemical Formulae X and Y-2. When the mole ratio is within the range, the binder may be more soluble in water and have stronger adherence.

In the electrode for a rechargeable lithium battery, the binder may be included in an amount of about 0.01% to about 50 wt %, e.g., about 1% to about 30 wt %, about 1% to about 20 wt %, about 3% to about 20 wt %, or about 1% to about 10 wt %, based on 100 wt % of the electrode composition. When the binder is included within the range, an electrode for a rechargeable lithium battery including the binder may well endure volume expansion of an active material and help secure sufficient adherence.

According to the present example embodiment, the active material may include Si, SiOₓ, a Si—C composite, a Si-Q alloy, graphite, or a combination thereof. The x is in the range of 0<x<2, and Q is an alkali metal, an alkaline-earth metal, a Group 13 to 16 element, a transition element, a rare earth element, or a combination thereof but not Si. Specific examples of Q may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, Ni, Mn, or a combination thereof.

When the active material is applied to a rechargeable lithium battery, the rechargeable lithium battery may have high-capacity. The active material may be about 300% to about 400% expanded during the charge and discharge, and may deteriorate stability or cycle-life characteristic of a rechargeable lithium battery. When the active material is used with the binder according to an embodiment, the binder may well endure expansion of the active material and work as a buffer layer. Accordingly, a rechargeable lithium battery including the binder may be stable and have excellent cycle-life characteristics.

When a binder such as styrene-butadiene rubber (SBR), carboxymethyl cellulose (CMC), and the like is applied to a negative electrode, a negative active material including greater than or equal to about 5 wt % of Si may not realize a desirable level of performance of a rechargeable lithium battery at all. When the Si is included in an amount of about 3 wt % or about 1.6 wt %, the negative active material may deteriorate cycle-life characteristic of a rechargeable lithium battery. The aforementioned binder may help provide good cycle-life characteristics and efficiency of a rechargeable lithium battery when Si is included in an amount of greater than or equal to about 5%, as well as in a smaller amount.

The electrode composition may further include a conductive material. The conductive material is the same as described above.

The electrode composition may further include a thickener. The thickener may help control phase separation of an active material in a slurry state and secure stability of an electrode composition. The thickener is the same as described above.

The electrode for a rechargeable lithium battery may be a negative electrode. The electrode composition may be a negative electrode composition, and the active material may be a negative active material.

When the binder according to an embodiment is applied with a negative active material including silicon (Si) to fabricate a negative electrode, improved effects may be provided. The binder according to an embodiment may be applied to a positive electrode and/or the negative electrode.

The current collector is the same as described above and thus descriptions thereof are not repeated.

Manufacturing Method of Electrode for Rechargeable Lithium Battery

In another example embodiment, a method of manufacturing the electrode for a rechargeable lithium battery includes mixing an active material, a solvent, and a binder to prepare an electrode composition, coating the electrode composition on a current collector, and heat-treating the current collector coated with the electrode composition.

The binder before heat-treating may include a copolymer including the repeating unit represented by Chemical Formula X, the repeating unit represented by Chemical Formula Y-1, the repeating unit represented by Chemical Formula Z, and the repeating unit having a fluoro substituent.

The binder after heat-treating may include a copolymer including the repeating unit represented by Chemical Formula X, the repeating unit represented by Chemical Formula Y-2, the repeating unit represented by Chemical Formula Z, and the repeating unit having a fluoro substituent.

A weight average molecular weight of the copolymer may range from about 10,000 to about 500,000,

A mole ratio of the repeating unit represented by Chemical Formula X may range from about 5% to about 35%, a mole ratio of the repeating unit represented by Chemical Formula Y-2 may range from about 5% to about 35%, a mole ratio of the repeating unit represented by Chemical Formula Z may range from about 20% to about 89.5%, and a mole ratio of the repeating unit having a fluoro substituent may range from about 0.5% to about 10%.

Chemical Formula X, Chemical Formula Y-1, Chemical Formula Y-2, Chemical Formula Z, and the repeating unit having a fluoro substituent are as described above.

The binder before heat-treating may be prepared by reacting a substituted or unsubstituted ethylene monomer, a substituted or unsubstituted maleic anhydride, and a substituted or unsubstituted amine, and then adding an acrylamide monomer and a monomer having a fluoro substituent.

In the manufacturing method, a repeating unit represented by Chemical Formula Y-1 may be converted into a repeating unit represented by Chemical Formula Y-2 by the heat-treating.

An electrode for a rechargeable lithium battery prepared using the manufacturing method according to an example embodiment may well endure volume expansion of an active material during the charge and discharge, and have excellent adherence among active material particles or the active material to a current collector, which may provide a rechargeable lithium battery having excellent stability, rate capability, and cycle-life characteristics.

The solvent may be an organic solvent or an aqueous solvent. The aqueous solvent may be a general aqueous solvent. For example, the solvent may include water, an alcohol, or a combination thereof. In an implementation, the solvent is water alone. The manufacturing method using the aqueous solvent may be environmentally-friendly.

In the manufacturing method of the electrode for a rechargeable lithium battery, the heat-treating may be performed at about 120° C. to about 300° C., e.g., about 120° C. to about 250° C., about 120° C. to about 200° C., about 150° C. to about 300° C., about 150° C. to about 250° C., or about 150° C. to about 200° C. According to an example embodiment, the heat-treating within these temperature ranges converts a repeating unit represented by Chemical Formula Y-1 into a repeating unit represented by Chemical Formula Y-2. Thus, an amic acid group may be converted into an imide group.

The heat-treating may be performed for about 10 minutes to about 5 hours, e.g., about 3 hours, or about 30 minutes to about 2 hours. According to an example embodiment, under the heat-treating condition, a repeating unit represented by Chemical Formula Y-1 is converted into a repeating unit represented by Chemical Formula Y-2.

The heat-treating may be performed in the air, or under an inert gas atmosphere or a vacuum atmosphere. For example, the heat-treating may be performed under the vacuum atmosphere.

In the method of manufacturing an electrode for a rechargeable lithium battery, the binder may be used in an amount of about 0.01% to about 50 wt %, e.g., about 1% to about 30 wt %, about 1% to about 20 wt %, about 3 to about 20 wt %, or about 1% to about 10 wt %, based on 100 wt % of the electrode composition. When the binder is included within the range, an electrode for a rechargeable lithium battery fabricated in the manufacturing method may well endure volume expansion of an active material and help secure sufficient adherence.

According to the present example embodiment, the active material may include Si, SiOₓ, a Si—C composite, a Si-Q alloy, graphite, or a combination thereof. The x is in the range of 0<x<2, and Q is an alkali metal, an alkaline-earth metal, a Group 13 to 16 element, a transition element, a rare earth element, or a combination thereof, but not Si.

The active material may provide a rechargeable lithium battery having high-capacity. An active material may be about 300% to about 400% expanded during the charge and discharge and deteriorate stability or cycle-life characteristic of a battery. When the active material is used with the binder according to an embodiment, the binder may well endure expansion of the active material and work as a buffer layer. Accordingly, a rechargeable lithium battery including the binder may be stable and have excellent cycle-life characteristic.

The manufacturing method of the electrode for a rechargeable lithium battery, and the current collector are as described above.

Rechargeable Lithium Battery

In an embodiment, a rechargeable lithium battery including the electrode for a rechargeable lithium battery, a separator, and an electrolyte is provided. In another embodiment, a rechargeable lithium battery including the electrode for a rechargeable lithium battery manufactured according to the method, a separator, and an electrolyte is provided.

Descriptions of the rechargeable lithium battery are the same as above.

The electrode may be a positive electrode or negative electrode. When the electrode is a negative electrode, improved effect may be provided. In another implementation, the electrode may be a positive electrode.

When the electrode is a negative electrode, the positive electrode may include a positive active material that is a compound that intercalates and deintercalates lithium (lithiated intercalation compound). Specific descriptions thereof are as described above.

The separator and electrolyte are as described above, and description thereof is not repeated.

Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Preparation of Binder

### Preparation Example 1

390 g of deionized water and 30 g of styrene-co-maleic anhydride were introduced into a 2 L reactor having a heater, a condenser, and an agitator, and then slowly combined with 11.5 g of 40% methylamine aqueous solution at room temperature and agitated for 10 minutes. The reactor was heated at 80° C. for 3 hours under a nitrogen atmosphere. A solution of 0.125 g of ammonium persulfate dissolved in 10 g of deionized water was added thereto and maintained for 20 minutes, and then dripped with a mixed aqueous solution of 63 g of acrylamide and 7 g of N,N-dimethylaminoethyl methacrylate in 180 g of deionized water for 2 hours. After maintaining the reaction for 1 hour and cooling at less than or equal to 40° C., an aqueous solution of 1.5 g of lithium hydroxide dissolved in 20 g of deionized water was dripped for 10 minutes and maintained for 30 minutes, to provide a binder having a solid content of 15.0%, pH 8.5, and a viscosity of 10,000 cps.

The obtained binder included a copolymer including repeating units represented by Chemical Formula X-1, Chemical Formula Y-11, Chemical Formula Z-11, and Chemical Formula V-2, and each mole ratio was 6%, 6%, 83.8%, and 4.2%, respectively. The obtained binder included lithium ions in an amount of 6.9 moles based on 100 moles of the copolymer. In addition, the obtained binder had a weight average molecular weight of 380,000.

[chemical structure]

### Preparation Example 2

390 g of deionized water and 30 g of styrene-co-maleic anhydride were introduced into a 2 L reactor having a heater, a condenser, and an agitator, and then slowly combined with 11.5 g of 40% methylamine aqueous solution at room temperature and agitated for 10 minutes. The reactor was heated to 80° C. under a nitrogen atmosphere and maintained for 3 hours. A solution of 0.125 g of ammonium persulfate dissolved in 10 g of deionized water was added thereto and maintained for 20 minutes, and then an aqueous solution of acrylamide (60 g of acrylamide dissolved in 180 g of deionized water) and a mixed solution of 0.5 g of 3-(meth)acryloxypropyltrimethoxy silane and 10 g of hydroxy fluoro polyether were dripped for each 2 hours. After maintaining the reaction for 1 hour and cooling at less than or equal to 40° C., to provide a binder having a solid content of 13.0%, pH 6.1, and a viscosity of 6,700 cps.

The obtained binder included repeating units represented by Chemical Formula X-1, Chemical Formula Y-11, Chemical Formula Z-11, and Chemical Formula T-11, and each mole ratio was 6.1%, 6.1%, 8.6%, and 1.8%, respectively. In addition, the obtained binder had a weight average molecular weight of 350,000.

### Manufacture of Rechargeable Lithium Battery Cell

### Examples 1 to 5 and Comparative Examples 1 and 2

### Example 1

The negative active material was prepared by mixing 27 wt % of “natural SiNW16 (Nanosys, Inc., U.S.A)” and 63 wt % of graphite “MAGV4”, and combining with 10 wt % of the binder obtained from Preparation Example 1 and water to provide a slurry. The natural SiNW16 has a structure of growing silicon nanowire to natural graphite, and the Si content in the negative active material was 16 wt %. In addition, the graphite MAGV4 was graphite in which artificial graphite (Showa Denko) and natural graphite (Mitsubishi) were mixed at 60:40.

The obtained negative electrode slurry was coated on a copper foil and dried at 110° C. to evaporate water, and compressed to provide a negative electrode having a thickness of 56 μm. The obtained negative electrode was vacuum-dried and heated at 200° C. for 1 hour to convert a repeating unit represented by Chemical Formula Y-11 into a repeating unit represented by Chemical Formula Y-21 according to Reaction Scheme 1. Thus, an imide repeating unit was obtained from an amic acid repeating unit.

[chemical structure]

The bottom graph in FIG. 2 indicates an infrared spectroscope analysis graph of the negative electrode obtained as in above. Referring to FIG. 2, a sharp peak was observed at the imide adsorption region of 1700 cm⁻¹, which confirmed that the imide repeating unit was synthesized from the aqueous system.

The negative electrode plate was shaped into a circular shape of 16 mm. Using a polypropylene separator and a counter electrode of lithium metal, and an electrolyte solution of 1.5 mol/L of LiPF₆ added into a mixed solvent of ethylene carbonate (EC):diethyl carbonate (DEC):fluoroethylene carbonate (FEC) at 5:75:20, a rechargeable lithium battery cell was fabricated.

### Example 2

A rechargeable lithium battery cell was fabricated in accordance with the same procedure as in Example 1, except that an artificial SiNW16 was used for the negative active material instead of the natural SiNW16. The artificial SiNW16 had a structure of growing silicon nanowire in artificial graphite.

### Example 3

A rechargeable lithium battery cell was fabricated in accordance with the same procedure as in Example 1, except that a pitch SiNW16 was used for the negative active material instead of the natural SiNW16. The pitch SiNW16 had a structure of growing silicon nanowire in the natural graphite and pitch-coating the same.

### Example 4

A rechargeable lithium battery cell was fabricated in accordance with the same procedure as in Example 1, except that 3HE was used for the graphite instead of MAGV4.

### Example 5

A rechargeable lithium battery cell was fabricated in accordance with the same procedure as in Example 1, except that SD13 (artificial graphite, Showa Denko) was used for the graphite instead of MAGV4.

### Comparative Example 1

A rechargeable lithium battery cell was fabricated in accordance with the same procedure as in Example 1, except that polyamideimide (PAI) was used for a binder in the negative electrode.

### Comparative Example 2

A rechargeable lithium battery cell was fabricated in accordance with the same procedure as in Example 1, except that 5 wt % of styrene-butadiene rubber (SBR) and 5 wt % of carboxymethyl cellulose (CMC) were used for a binder in the negative electrode.

Table 1 schematically shows the compositions of negative active materials and the binders used in Examples 1 to 3 and Comparative Examples 1 to 2.

TABLE 1

| | | | | | | | | Comparative | |
|---|---|---|---|---|---|---|---|---|---|
| | | | Examples | | | | | Examples | |
| | | | 1 | 2 | 3 | 4 | 5 | 1 | 2 |
| Active | SiNW16 | Natural | 27 | | | 27 | 27 | 27 | 27 |
| material | | | | | | | | | |
| | | Artificial | | 27 | | | | | |
| | | Pitch | | | 27 | | | | |
| | Graphite | MAGV4 | 63 | 63 | 63 | | | 63 | 63 |
| | | SD13 | | | | 63 | | | |
| | | 3HE | | | | | 63 | | |

| | | | | | | | | |
|---|---|---|---|---|---|---|---|---|
| Binder | SBR | | | | | | | 5 |
| | CMC | | | | | | | 5 |
| | Preparation | 10 | 10 | 10 | 10 | 10 | | |
| | Example 1 | | | | | | | |
| | PAI | | | | | | 10 | |

| | | | | | | | |
|---|---|---|---|---|---|---|---|
| Discharge capacity (mAh/g) | 488 | 504 | 461 | 490 | 492 | 518 | 403 |
| Retention capacity | 84 | 87 | 94 | 84 | 83 | 46 | 78 |
| (%) @50 cycle | | | | | | | |
| Initial efficiency (%) | 91 | 89 | 89 | 90 | 88 | 80 | 85 |

### Examples 11 to 14 and Comparative Examples 11 to 12

### Example 11

As a negative active material, 27 wt % of “natural SiNW16” and 63 wt % of graphite of “MAGV4” were mixed, and added with 10 t % of the binder obtained from Preparation Example 2 and water to provide a slurry. The obtained negative electrode slurry was coated on a copper foil and dried at 110° C. to evaporate water, and compressed to provide a negative electrode having a thickness of 56 μm. The negative electrode plate was shaped into a circular shape of 16 mm. Using a polypropylene separator and a counter electrode of lithium metal, and an electrolyte solution of LiPF₆ added to a mixed solvent of ethylene carbonate (EC):diethyl carbonate (DEC):fluoro ethylene carbonate (FEC) 5:75:20 in a concentration of 1.5 mol/L, a rechargeable lithium battery cell was fabricated.

### Example 12

A rechargeable lithium battery cell was fabricated in accordance with the same procedure as in Example 11, except that 3HE was used for the graphite instead of MAGV4.

### Example 13

A rechargeable lithium battery cell was fabricated in accordance with the same procedure as in Example 11, except that an artificial SiNW16 was used for the negative active material instead of the natural SiNW16.

### Example 14

A rechargeable lithium battery cell was fabricated in accordance with the same procedure as in Example 11, except that “pitch SiNW16” was used for the negative active material instead of “natural SiNW16.”

### Comparative Example 11

A rechargeable lithium battery cell was fabricated in accordance with the same procedure as in Example 11, except that 10 wt % of polyamideimide (PAI) was used for a binder in the negative electrode.

Table 2 schematically shows the compositions of negative active materials and the binders used in Examples 11 to 14 and Comparative Examples 11 to 12.

### Comparative Example 12

A rechargeable lithium battery cell was fabricated in accordance with the same procedure as in Example 11, except that 5 wt % of styrene-butadiene rubber (SBR) and 5 wt % of carboxymethyl cellulose (CMC) were used for a binder in the negative electrode.

TABLE 2

| | | | | | | | Comparative | |
|---|---|---|---|---|---|---|---|---|
| | | | Examples | | | | Examples | |
| | | | 11 | 12 | 13 | 14 | 11 | 12 |
| Ac- | SiNW16 | Natural | 27 | 27 | | | 27 | 27 |
| tive | | | | | | | | |
| mate- | | | | | | | | |
| rial | | | | | | | | |
| | | Artificial | | | 27 | | | |
| | | Pitch | | | | 27 | | |
| | Graphite | MAGV4 | 63 | | 63 | 63 | 63 | 63 |
| | | 3HE | | 63 | | | | |

| | | | | | | | |
|---|---|---|---|---|---|---|---|
| Bind- | SBR | | | | | | 5 |
| er | CMC | | | | | | 5 |
| | Preparation Example 2 | 10 | 10 | 10 | 10 | | |
| | PAI | | | | | 10 | |

| | | | | | | |
|---|---|---|---|---|---|---|
| Discharge capacity (mAh/g) | 506 | 497 | 505 | 466 | 518 | 403 |
| Retention capacity (%) @50 | 80 | 92 | 82 | 85 | 46 | 78 |
| cycle | | | | | | |
| Initial efficiency (%) | 89 | 88 | 90 | 90 | 80 | 85 |

### Experimental Example 1

### Capacity Characteristic

The rechargeable lithium battery cells obtained from Examples 1 to 5, Comparative Examples 1 to 2, Examples 11 to 14, and Comparative Examples 11 to 12 were measured for a discharge capacity after charging and discharging at 0.1 C at a voltage range from 1.5V to 0.01V, and the results are shown in Table 1 and Table 2.

Referring to Table 1, the cases of Examples 1 to 5 had a higher discharge capacity compared to that of Comparative Example 2 including a styrene-butadiene rubber and a carboxymethyl cellulose as a binder. The cases of Examples 11 to 14 had a higher discharge capacity to that of Comparative Example 12 as shown in Table 2.

### Experimental Example 2

### Cycle-Life Characteristic

The rechargeable lithium battery cells obtained from Examples 1 to 5, Comparative Examples 1 to 2, Examples 11 to 14, and Comparative Examples 11 to 12 were measured for a capacity rate of the 50 cycle to the 1 cycle under the condition of 1C, and the results are shown in Table 1 and Table 2.

Referring to Table 1, the cases of Examples 1 to 5 had a higher capacity retention compared to that of Comparative Example 1 including polyamideimide as a binder, which was higher than that of Comparative Example 2. The cases of Examples 11 to 14 had a higher discharge capacity than that of Comparative Example 11, which was higher than that of Comparative Example 12.

### Experimental Example 3

### Initial Efficiency

The rechargeable lithium battery cells obtained from Examples 1 to 5, Comparative Examples 1 to 2, Examples 11 to 14, and Comparative Examples 11 to 12 were measured for a charge capacity and a discharge capacity after charging and discharging at 0.1 C, and the ratio of discharge capacity to charge capacity was calculated. The results are shown in Table 1 and Table 2.

Referring to Table 1, all cases of Examples 1 to 5 had a high initial efficiency compared to those of Comparative Examples 1 and 2. In addition, the cases of Examples 11 to 14 had higher initial efficiency compared to those of Comparative Examples 11 and 12.

The cases of Comparative Examples 1 and 11 (including polyamideimide as a binder) had good discharge capacity and adherence, but the capacity retention was low at the 50 cycle, indicating poor cycle-life characteristics. The cases of Comparative Examples 2 and 12 (including a styrene-butadiene rubber and a carboxymethyl cellulose binder) had poor discharge capacity, capacity retention, and initial efficiency.

The cases of Examples 1 to 5 and 11 to 14 (including the binder according to an embodiment) had excellent discharge capacity, capacity retention, and initial efficiency.

By way of summation and review, a positive active material for a lithium rechargeable battery may use a lithium-transition metal oxide being capable of intercalating lithium such as LiCoO₂, LiMn₂O₄, LiNi₁₋ₓCoₓO₂ (0<x<1), and the like.

A negative active material for a lithium rechargeable battery may use various carbon-based materials such as artificial graphite, natural graphite, and hard carbon capable of intercalating and deintercalating lithium ions. A battery having high energy density may use a negative active material having a high theoretical capacity density. Si, Sn, and Ge alloyed with lithium and an oxide thereof and an alloy thereof have drawn attention. A Si-based negative active material may provide high charge capacity and may be applied to a high-capacity battery. The Si-based negative active material may be about 300% to about 400% expanded during the charge and discharge.

As described above, a binder that helps control expansion of the Si-based negative active material is desired. An embodiment provides a binder for a rechargeable lithium battery. The binder may provide strong adherence and may endure expansion of an active material.

Another embodiment provides an electrode for a rechargeable lithium battery, which may have excellent stability, rate capability, and cycle-life characteristics. Still another embodiment provides a method of preparing the electrode for a rechargeable lithium battery. Still another embodiment provides a rechargeable lithium battery.

The binder for a rechargeable lithium battery according to an embodiment may provide strong adherence, may endure expansion of an active material, and may be environmentally-friendly. An electrode for a rechargeable lithium battery including the same, an electrode for a rechargeable lithium battery manufactured according to a manufacturing method, and a rechargeable lithium battery including the electrode for a rechargeable lithium battery may be stable, and may exhibit rate capability and cycle-life characteristics.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in claims.

What is claimed is:

1. A binder for a rechargeable lithium battery, the binder comprising:
a copolymer including a repeating unit represented by Chemical Formula X, a repeating unit represented by Chemical Formula Y-1, and a repeating unit represented by Chemical Formula Z, and
lithium ions, wherein:
a weight average molecular weight of the copolymer is about 10,000 to about 500,000,
a mole ratio of the repeating unit represented by Chemical Formula X is about 5% to about 35%, a mole ratio of the repeating unit represented by Chemical Formula Y-1 is about 5% to about 35%, and a mole ratio of the repeating unit represented by Chemical Formula Z is about 30% to about 90%, [chemical structure]
wherein,
R¹ to R⁴ are each independently hydrogen, a substituted or unsubstituted C1 to C30 alkyl group, or a substituted or unsubstituted C6 to C30 aryl group,
L is a substituted or unsubstituted C2 to C10 alkenylene group, and
n is 0 or 1, [chemical structure]
wherein,
R⁵ and R⁶ are each independently hydrogen, or a substituted or unsubstituted C1 to C30 alkyl group, and
R⁷ is a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, [chemical structure]
wherein,
R¹¹ is hydrogen, or a substituted or unsubstituted C1 to C30 alkyl group, and
R¹² and R¹³ are each independently hydrogen, a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, or R¹² and R¹³ are linked to each other to form a ring.

2. The binder for a rechargeable lithium battery as claimed in claim 1, wherein the lithium ions are present in the binder in an amount of about 0.1 to about 10 moles, based on 100 moles of the copolymer.

3. The binder for a rechargeable lithium battery as claimed in claim 1, wherein the binder for a rechargeable lithium battery is an aqueous binder.

4. The binder for a rechargeable lithium battery as claimed in claim 1, wherein the copolymer further includes at least one of repeating structures represented by Chemical Formulae W-1 to W-5: [chemical structure]
wherein, R²¹, R²³, R²⁵, R²⁷, and R³⁰ are each independently hydrogen, or a substituted or unsubstituted C1 to C30 alkyl group,
R²², R²⁴, and R²⁶ are each independently hydrogen, a substituted or unsubstituted C1 to C30 alkyl group, a substituted or unsubstituted C2 to C20 alkenyl group, a substituted or unsubstituted C2 to C20 alkynyl group, a substituted or unsubstituted C3 to C8 cycloalkyl group, a substituted or unsubstituted C6 to C30 aryl group, a substituted or unsubstituted C1 to C30 heteroaryl group, a silane group, a C1 to C20 alkylsilane group, a C1 to C20 alkoxysilane group, or a C1 to C20 alkylamine group, and
R²⁸, R²⁹, R³¹, and R³² are each independently hydrogen, a substituted or unsubstituted C1 to C30 alkyl group, a substituted or unsubstituted C2 to C20 alkenyl group, a substituted or unsubstituted C2 to C20 alkynyl group, a C3 to C8 cycloalkyl group, a substituted or unsubstituted C6 to C30 aryl group, a substituted or unsubstituted C1 to C30 heteroaryl group, a silane group, a C1 to C20 alkylsilane group, a C1 to C20 alkoxysilane group, or a C2 to C20 carbonyl group, or
R²⁸ and R²⁹ are linked to each other to form a ring, and R³¹ and R³² are linked to each other to form a ring.

5. An electrode for a rechargeable lithium battery, the electrode comprising:
a current collector, and
an electrode composition disposed on one side or both sides of the current collector, the electrode composition including an active material and a binder, wherein:
the binder includes a copolymer including a repeating unit represented by Chemical Formula X, a repeating unit represented by Chemical Formula Y-2, and a repeating unit represented by Chemical Formula Z, and lithium ions,
a weight average molecular weight of the copolymer is about 10,000 to about 500,000,
a mole ratio of the repeating unit represented by Chemical Formula X is about 5% to about 35%, a mole ratio of the repeating unit represented by Chemical Formula Y-2 is about 5% to about 35%, and a mole ratio of the repeating unit represented by Chemical Formula Z is about 30% to about 90%: [chemical structure]
wherein,
R¹ to R⁴ are each independently hydrogen, a substituted or unsubstituted C1 to C30 alkyl group, or a substituted or unsubstituted C6 to C30 aryl group,
L is a substituted or unsubstituted C2 to C10 alkenylene group, and
n is 0 or 1, [chemical structure]
wherein,
R⁵ and R⁶ are each independently hydrogen, or a substituted or unsubstituted C1 to C30 alkyl group, and
R⁷ is a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, [chemical structure]
wherein,
R¹¹ is hydrogen, or a substituted or unsubstituted C1 to C30 alkyl group, and
R¹² and R¹³ are each independently hydrogen, a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, or R¹² and R¹³ are linked to each other to form a ring.

6. The electrode as claimed in claim 5, wherein the repeating unit represented by the above Chemical Formula Y-2 is prepared by heat-treating a repeating structure represented by Chemical Formula Y-1: [chemical structure]
wherein,
R⁵ and R⁶ are each independently hydrogen, or a substituted or unsubstituted C1 to C30 alkyl group, and
R⁷ is a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group.

7. The electrode as claimed in claim 5, wherein the copolymer further includes at least one of repeating structures represented by Chemical Formulae W-1 to W-5: [chemical structure]
wherein,
R²¹, R²³, R²⁵, R²⁷, and R³⁰ are each independently hydrogen, or a substituted or unsubstituted C1 to C30 alkyl group,
R²², R²⁴, and R²⁶ are each independently hydrogen, a substituted or unsubstituted C1 to C30 alkyl group, a substituted or unsubstituted C2 to C20 alkenyl group, a substituted or unsubstituted C2 to C20 alkynyl group, a substituted or unsubstituted C3 to C8 cycloalkyl group, a substituted or unsubstituted C6 to C30 aryl group, a substituted or unsubstituted C1 to C30 heteroaryl group, a silane group, a C1 to C20 alkylsilane group, a C1 to C20 alkoxysilane group, or a C1 to C20 alkylamine group, and
in the above Chemical Formula W-4 and W-5, R²⁸, R²⁹, R³¹ and R³² are each independently hydrogen, a substituted or unsubstituted C1 to C30 alkyl group, a substituted or unsubstituted C2 to C20 alkenyl group, a substituted or unsubstituted C2 to C20 alkynyl group, a C3 to C8 cycloalkyl group, a substituted or unsubstituted C6 to C30 aryl group, a substituted or unsubstituted C1 to C30 heteroaryl group, a silane group, a C1 to C20 alkylsilane group, a C1 to C20 alkoxysilane group, or a C2 to C20 carbonyl group, or
R²⁸ and R²⁹ are linked to each other to form a ring, and R³¹ and R³² are linked to each other to form a ring.

8. The electrode as claimed in claim 5, wherein the active material includes Si, SiOₓ, a Si—C composite, a Si-Q alloy, graphite, or a combination thereof,
wherein x is in the range of 0<x<2, and Q is an alkali metal, an alkaline-earth metal, a Group 13 to 16 element, a transition element, a rare earth element, or a combination thereof but not Si.

9. A method of manufacturing the electrode for a rechargeable lithium battery, the method comprising:
mixing an active material, a solvent, and a binder to prepare an electrode composition,
coating the electrode composition on a current collector, and
heat-treating the current collector coated with the electrode composition, wherein:
the binder before heat-treating includes a copolymer including a repeating unit represented by Chemical Formula X, a repeating unit represented by Chemical Formula Y-1, and a repeating unit represented by Chemical Formula Z, and lithium ions,
the binder after heat-treating includes a copolymer including a repeating unit represented by Chemical Formula X, a repeating unit represented by Chemical Formula Y-2, and a repeating unit represented by Chemical Formula Z, and lithium ions,
a weight average molecular weight of the copolymer is about 10,000 to about 500,000, and
a mole ratio of the repeating unit represented by Chemical Formula X is about 5% to about 35%, a mole ratio of the repeating unit represented by Chemical Formula Y-2 is about 5% to about 35%, and a mole ratio of the repeating unit represented by Chemical Formula Z is about 30% to about 90%, [chemical structure]
wherein, in the above Chemical Formula X,
R¹ to R⁴ are each independently hydrogen, a substituted or unsubstituted C1 to C30 alkyl group, or a substituted or unsubstituted C6 to C30 aryl group,
L is a substituted or unsubstituted C2 to C10 alkenylene group, and
n is 0 or 1, [chemical structure]
wherein,
R⁵ and R⁶ are each independently hydrogen, or a substituted or unsubstituted C1 to C30 alkyl group, and
R⁷ is a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, [chemical structure]
wherein,
R⁵ and R⁶ are each independently hydrogen, or a substituted or unsubstituted C1 to C30 alkyl group, and
R⁷ is a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, [chemical structure]
wherein,
R¹¹ is hydrogen, or a substituted or unsubstituted C1 to C30 alkyl group, and
R¹² and R¹³ are each independently hydrogen, a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, or R¹² and R¹³ are linked to each other to form a ring.

10. The method as claimed in claim 9, wherein the heat-treating is performed at about 120° C. to about 300° C.

11. A rechargeable lithium battery comprising the electrode as claimed in claim 5, a separator, and an electrolyte.

12. A binder for a rechargeable lithium battery, the binder comprising:
a copolymer including a repeating unit represented by Chemical Formula X, a repeating unit represented by Chemical Formula Y-1, a repeating unit represented by Chemical Formula Z, and a repeating unit having a fluoro substituent, wherein:
the repeating unit having a fluoro substituent is a repeating unit represented by one of Chemical Formulae T-1 to T-5,
a weight average molecular weight of the copolymer is about 10,000 to about 500,000,
a mole ratio of the repeating unit represented by Chemical Formula X is about 5% to about 35%, a mole ratio of the repeating unit represented by Chemical Formula Y-1 is about 5% to about 35%, a mole ratio of the repeating unit represented by Chemical Formula Z is about 20% to about 89.5%, and a mole ratio of the repeating unit having a fluoro substituent is about 0.5% to about 10%, [chemical structure]
wherein,
R¹ to R⁴ are each independently hydrogen, a substituted or unsubstituted C1 to C30 alkyl group, or a substituted or unsubstituted C6 to C30 aryl group,
L is a substituted or unsubstituted C2 to C10 alkenylene group, and
n is 0 or 1, [chemical structure]
wherein,
R⁵ and R⁶ are each independently hydrogen, or a substituted or unsubstituted C1 to C30 alkyl group, and
R⁷ is a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, [chemical structure]
wherein,
R¹¹ is hydrogen, or a substituted or unsubstituted C1 to C30 alkyl group, and
R¹² and R¹³ are each independently hydrogen, a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, or R¹² and R¹³ are linked to each other to form a ring, [chemical structure]
wherein, R⁴¹, R⁴³, R⁴⁵, R⁴⁷, and R⁵⁰ are each independently hydrogen, or a substituted or unsubstituted C1 to C30 alkyl group,
R⁴², R⁴⁴, and R⁴⁶ are each independently a fluoro group, a fluoro-substituted C1 to C30 alkyl group, a fluoro-substituted C2 to C20 alkenyl group, a fluoro-substituted C2 to C20 alkynyl group, a fluoro-substituted C3 to C8 cycloalkyl group, a fluoro-substituted C6 to C30 aryl group, a fluoro-substituted C1 to C30 heteroaryl group, a fluoro-substituted silane group, a fluoro-substituted C1 to C20 alkylsilane group, a fluoro-substituted C1 to C20 alkoxysilane group, or a fluoro-substituted C1 to C20 alkylamine group,
at least one of R⁴⁸ and R⁴⁹ and at least one of R⁵¹ and R⁵² are a fluoro group, a fluoro-substituted C1 to C30 alkyl group, a fluoro-substituted C2 to C20 alkenyl group, a fluoro-substituted C2 to C20 alkynyl group, a fluoro-substituted C3 to C8 cycloalkyl group, a fluoro-substituted C6 to C30 aryl group, a fluoro-substituted C1 to C30 heteroaryl group, a fluoro-substituted silane group, a fluoro-substituted C1 to C20 alkylsilane group, a fluoro-substituted C1 to C20 alkoxysilane group, or a fluoro-substituted C2 to C20 carbonyl group, or
R⁴⁸ and R⁴⁹ are linked to each other to form a ring, and R⁵¹ and R⁵² are linked to each other to form a ring.

13. The binder for a rechargeable lithium battery as claimed in claim 12, wherein the binder for a rechargeable lithium battery is an aqueous binder.

14. An electrode for a rechargeable lithium battery, comprising:
a current collector, and
an electrode composition disposed on one side or both sides of the current collector, the electrode composition including an active material and a binder, wherein:
the binder includes a copolymer including a repeating unit represented by Chemical Formula X, a repeating unit represented by Chemical Formula Y-2, a repeating unit represented by Chemical Formula Z, and a repeating unit having a fluoro substituent,
the repeating unit having a fluoro substituent is a repeating unit represented by one of Chemical Formulae T-1 to T-5,
a weight average molecular weight of the copolymer is about 10,000 to about 500,000, and
a mole ratio of the repeating unit represented by Chemical Formula X is about 5% to about 35%, a mole ratio of the repeating unit represented by Chemical Formula Y-2 is about 5% to about 35%, a mole ratio of the repeating unit represented by Chemical Formula Z is about 20% to about 89.5%, and a mole ratio of the repeating unit having a fluoro substituent is 0.5% to about 10%, [chemical structure]
wherein,
R¹ to R⁴ are each independently hydrogen, a substituted or unsubstituted C1 to C30 alkyl group, or a substituted or unsubstituted C6 to C30 aryl group,
L is a substituted or unsubstituted C2 to C10 alkenylene group, and
n is 0 or 1, [chemical structure]
wherein,
R⁵ and R⁶ are each independently hydrogen, or a substituted or unsubstituted C1 to C30 alkyl group,
R⁷ is a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, and
a mole ratio of Chemical Formula X:Chemical Formula Y-2 is about 90:10 to about 10:90, [chemical structure]
wherein,
R¹¹ is hydrogen, or a substituted or unsubstituted C1 to C30 alkyl group, and
R¹² and R¹³ are each independently hydrogen, a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, or R¹² and R¹³ are linked to each other to form a ring, [chemical structure]
wherein,
R⁴¹, R⁴³, R⁴⁵, R⁴⁷, and R⁵⁰ are each independently hydrogen, or a substituted or unsubstituted C1 to C30 alkyl group,
R⁴², R⁴⁴, and R⁴⁶ are each independently a fluoro group, a fluoro-substituted C1 to C30 alkyl group, a fluoro-substituted C2 to C20 alkenyl group, a fluoro-substituted C2 to C20 alkynyl group, a fluoro-substituted C3 to C8 cycloalkyl group, a fluoro-substituted C6 to C30 aryl group, a fluoro-substituted C1 to C30 heteroaryl group, a fluoro-substituted silane group, a fluoro-substituted C1 to C20 alkylsilane group, a fluoro-substituted C1 to C20 alkoxysilane group, or a fluoro-substituted C1 to C20 alkylamine group,
at least one of R⁴⁸ and R⁴⁹ and at least one of R⁵¹ and R⁵² are a fluoro group, a fluoro-substituted C1 to C30 alkyl group, a fluoro-substituted C2 to C20 alkenyl group, a fluoro-substituted C2 to C20 alkynyl group, a fluoro-substituted C3 to C8 cycloalkyl group, a fluoro-substituted C6 to C30 aryl group, a fluoro-substituted C1 to C30 heteroaryl group, a fluoro-substituted silane group, a fluoro-substituted C1 to C20 alkylsilane group, a fluoro-substituted C1 to C20 alkoxysilane group, or a fluoro-substituted C2 to C20 carbonyl group, or
R⁴⁸ and R⁴⁹ are linked to each other to form a ring, and R⁵¹ and R⁵² are linked to each other to form a ring.

15. The electrode as claimed in claim 14, wherein the repeating unit represented by Chemical Formula Y-2 is prepared by heat-treating a repeating structure represented by Chemical Formula Y-1, [chemical structure]
wherein,
R⁵ and R⁶ are each independently hydrogen, or a substituted or unsubstituted C1 to C30 alkyl group, and
R⁷ is a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group.

16. The electrode as claimed in claim 14, wherein the active material includes Si, SiOₓ, a Si—C composite, a Si-Q alloy, graphite, or a combination thereof,
wherein x is in the range of 0<x<2, and Q is an alkali metal, an alkaline-earth metal, a Group 13 to 16 element, a transition element, a rare earth element, or a combination thereof but not Si.

17. A method of manufacturing an electrode for a rechargeable lithium battery, the method comprising:
mixing an active material, a solvent, and a binder to prepare an electrode composition,
coating the electrode composition on a current collector, and
heat-treating the current collector coated with the electrode composition, wherein:
the binder before heat-treating includes a copolymer including a repeating unit represented by Chemical Formula X, a repeating unit represented by Chemical Formula Y-1, and a repeating unit represented by Chemical Formula Z, and lithium ions,
the binder after heat-treating includes a copolymer including a repeating unit represented by Chemical Formula X, a repeating unit represented by Chemical Formula Y-2, a repeating unit represented by Chemical Formula Z, and a repeating unit having a fluoro substituent,
a weight average molecular weight of the copolymer is about 10,000 to about 500,000,
a mole ratio of the repeating unit represented by Chemical Formula X is about 5% to about 35%, a mole ratio of the repeating unit represented by Chemical Formula Y-2 is about 5% to about 35%, a mole ratio of the repeating unit represented by Chemical Formula Z is about 20% to about 89.5%, and a mole ratio of the repeating unit having a fluoro substituent is 0.5% to about 10%, [chemical structure]
wherein,
R¹ to R⁴ are each independently hydrogen, a substituted or unsubstituted C1 to C30 alkyl group, or a substituted or unsubstituted C6 to C30 aryl group,
L is a substituted or unsubstituted C2 to C10 alkenylene group, and
n is 0 or 1, [chemical structure]
wherein,
R⁵ and R⁶ are each independently hydrogen, or a substituted or unsubstituted C1 to C30 alkyl group, and
R⁷ is a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, [chemical structure]
wherein,
R⁵ and R⁶ are each independently hydrogen, or a substituted or unsubstituted C1 to C30 alkyl group, and
R⁷ is a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, [chemical structure]
wherein,
R¹¹ is hydrogen, or a substituted or unsubstituted C1 to C30 alkyl group,
R¹² and R¹³ are each independently hydrogen, a substituted or unsubstituted C1 to C30 alkyl group, a substituted or unsubstituted C2 to C10 alkenyl group, a substituted or unsubstituted C2 to C10 alkynyl group, a substituted or unsubstituted C1 to C10 alkoxy group, a substituted or unsubstituted C3 to C10 cycloalkyl group, a substituted or unsubstituted C6 to C30 aryl group, or a substituted or unsubstituted C1 to C30 heteroaryl group, or R¹² and R¹³ are linked to each other to form a ring, [chemical structure]
wherein,
R⁴¹, R⁴³, R⁴⁵, R⁴⁷, and R⁵⁰ are each independently hydrogen, or a substituted or unsubstituted C1 to C30 alkyl group,
R⁴², R⁴⁴, and R⁴⁶ are each independently a fluoro group, a fluoro-substituted C1 to C30 alkyl group, a fluoro-substituted C2 to C20 alkenyl group, a fluoro-substituted C2 to C20 alkynyl group, a fluoro-substituted C3 to C8 cycloalkyl group, a fluoro-substituted C6 to C30 aryl group, a fluoro-substituted C1 to C30 heteroaryl group, a fluoro-substituted silane group, a fluoro-substituted C1 to C20 alkylsilane group, a fluoro-substituted C1 to C20 alkoxysilane group, or a fluoro-substituted C1 to C20 alkylamine group,
at least one of R⁴⁸ and R⁴⁹ and at least one of R⁵¹ and R⁵² are a fluoro group, a fluoro-substituted C1 to C30 alkyl group, a fluoro-substituted C2 to C20 alkenyl group, a fluoro-substituted C2 to C20 alkynyl group, a fluoro-substituted C3 to C8 cycloalkyl group, a fluoro-substituted C6 to C30 aryl group, a fluoro-substituted C1 to C30 heteroaryl group, a fluoro-substituted silane group, a fluoro-substituted C1 to C20 alkylsilane group, a fluoro-substituted C1 to C20 alkoxysilane group, or a fluoro-substituted C2 to C20 carbonyl group, or
R⁴⁸ and R⁴⁹ are linked to each other to form a ring, and R⁵¹ and R⁵² are linked to each other to form a ring.

18. The method as claimed in claim 17, wherein the heat-treating is performed at about 120° C. to about 300° C.

19. The method as claimed in claim 17, wherein the solvent includes water, an alcohol, or a combination thereof.

20. A rechargeable lithium battery comprising the electrode as claimed in claim 14, a separator, and an electrolyte.
